(19) United States
(12) Patent Application Publication
(10) Pub. No.: US 2026/0365088 A1
(43) Pub. Date: Nov. 19, 2026

(54) COMPONENT FOR VEHICLE INTERIOR

(71) Applicant: Yanfeng International Automotive Technology Co. Ltd., Novi, MI (US)

(72) Inventors: Kurt Seibold, Farmington Hills, MI (US); Nathan Feldman, Novi, MI (US)

(21) Appl. No.: 19/730,403

(22) Filed: Jul. 2, 2026

Related U.S. Application Data
(63) Continuation of application No. PCT/US2025/014676, filed on Feb. 5, 2025.
(60) Provisional application No. 63/550,132, filed on Feb. 6, 2024.

(51) Int. Cl. B60N 2/22; B60N 2/04; B60N 2/64; B60N 2/90

(52) U.S. Cl. CPC B60N 2/22; B60N 2/04; B60N 2/64; B60N 2/995

(57) ABSTRACT

A component for a vehicle interior comprising a seat assembly is disclosed. The seat assembly may comprise a mounting/base and a seat comprising a seat base and a seat back; the seat base may comprise a cushion; the seat base may be configured for movement relative to the base; the seat back may be configured for movement relative to the seat base; the seat base may comprise a leg support and a leg support mechanism comprising a linkage; the support may comprise a support member coupled to the linkage. The support/member may comprise a stiff/compliant panel configured to bend/deform or contour in movement such as to provide an equilibrium effect in reaction/response to an input/load and/or mass and position of the occupant; the support/member may comprise a curved/spring panel. The seat may be configured to move between a default state, a raised state, a lowered state and a recumbent state.

### CROSS-REFERENCE TO RELATED APPLICATIONS

The present application is a continuation of PCT/International Patent Application No. PCT/US2025/014676 titled “COMPONENT FOR VEHICLE INTERIOR” filed Feb. 5, 2025, which claims priority to U.S. Provisional Patent Application No. 63/550,132 titled “COMPONENT FOR VEHICLE INTERIOR” filed Feb. 6, 2024.

The present application claims priority to and incorporates by reference in full the following patent applications: (a) U.S. Provisional Patent Application No. 63/550,132 titled “COMPONENT FOR VEHICLE INTERIOR” filed Feb. 6, 2024; (b) PCT/International Patent Application No. PCT/US2025/014676 titled “COMPONENT FOR VEHICLE INTERIOR” filed Feb. 5, 2025.

### FIELD

The present invention relates to a component/seat assembly for a vehicle interior.

### BACKGROUND

It is known to provide a seat assembly for occupants in a vehicle interior.

It would be advantageous to provide an improved seat assembly.

### SUMMARY

The present invention relates to a component for a vehicle interior comprising a seat assembly comprising a base and a seat comprising a seat base and a seat back; the seat base may comprise a seat cushion; seat base may be configured for movement relative to the base; the seat back may be configured for movement relative to the seat base; the seat base may comprise a leg support and a leg support mechanism; the leg support mechanism may comprise a linkage; the leg support may comprise a support member coupled to the linkage; the leg support mechanism may be configured to facilitate movement of the leg support between a retracted position and an extended position. The support member of the leg support may be configured for deflection and/or extension and/or retraction. The support member may comprise a support panel configured to bend and/or contour and/or deform; the support panel may comprise a sheet member comprising a shape. The linkage of the leg support mechanism may be configured to facilitate movement of the leg support between the retracted position and the extended position. The support member of the leg support is connected to the seat base frame by the linkage of the leg support mechanism. The retracted position of the leg support may comprise deforming of the support member; the extended position of the leg support may comprise extension of the support member. The support member may comprise a support panel comprising at least one of a support plate or a curved plate or sheet steel or pre-stressed sheet steel or spring steel or a spring steel plate or a sheet member; the support panel may be configured to deflect under a load. The support panel may comprise the sheet member connected between the seat base frame and the linkage; the sheet member may comprise at least one of a metal sheet and/or sheet steel and/or spring steel. The retracted position of the leg support may comprise bending of the sheet member comprising the support panel; the extended position of the leg support may comprise flattening of the sheet member comprising the support panel. The linkage of the leg support mechanism may comprise a base link and a connector link; the support member of the leg support is connected to the connector link of the linkage of the leg support mechanism; extension of the leg support may comprise extension of the linkage. The support member may comprise the support panel; the retracted position of the leg support may comprise curving of the support panel and retraction of the linkage; the extended position of the leg support may comprise flattening of the support panel and extension of the linkage; retraction of the linkage may comprise retraction of the linkage into the seat base frame. The sheet member is installed in a curved form; the sheet member may be configured to deform under a load and return toward the curved form after removal of the load; the sheet member provides a front of the seat base. The support member may be configured to provide the shape of a curve at the front of the seat base when the leg support is in the retracted position; the extended position of the leg support may comprise extension at the front of the seat base by flattening of the support member.

The present invention relates to a seat assembly for a vehicle interior comprising a base and a seat coupled to the base; the seat may comprise a seat base and a seat back; the seat may be configured to be movable relative to the base; the seat back may be configured to be movable relative to the seat base; the seat base may comprise a seat base frame and a leg support; the leg support may comprise a support member configured to provide a support for a leg of an occupant of the seat; the leg support is coupled to a leg support mechanism; the leg support mechanism may comprise a linkage coupled to the support member of the leg support; the leg support mechanism is connected to the seat base frame; the leg support mechanism may be configured to facilitate movement of the leg support between a retracted position and an extended position; the support member may comprise a support panel and/or a support member and/or a sheet member. The seat back may be configured to provide a reclined position relative to the seat base and the leg support may be configured to provide the extended position. The linkage of the leg support mechanism may be configured to facilitate movement of support member of the leg support to provide the retracted position and the extended position. The support member may comprise a panel or a panel sheet or a curved panel or a stiff panel or a panel member or a spring steel sheet or a tensile element or a biased spring member or a link sheet member or a support panel or a spring member or a spring member coupled to a frame of the seat base and a connector link of the linkage. The leg support may be configured to be actuated by mass and position of an occupant in the seat; the leg support may be configured to provide a floating feel for the occupant in the seat; the leg support may be configured to provide equilibrium for the occupant in the seat; the leg support mechanism may be configured to provide an equilibrium feel by movement in response to actuation and/or mass and position of the occupant; the leg support mechanism may be configured to provide an equilibrium feel by movement of the support plate. The support member may comprise a support plate and movement of the support panel may comprise deflection and/or extension and/or retraction; the leg support mechanism may be configured to provide an equilibrium by movement of the support member and the linkage; the leg support mechanism may be configured to provide an equilibrium by deflection and/or bending of the support member comprising a panel; the support member may comprise a compliant panel; the support member may be configured to bend and/or contour and/or deform. The support panel may comprise a curvature; the curvature may comprise a default curvature; the curvature is responsive to an input; the curvature is reactive to a load from an occupant. The seat base may comprise a nose; the nose may be configured to preserve a shape for the seat base; the shape of the nose is responsive to a load from occupant; the nose may be configured for movement with the leg support; the nose may be configured to shift with the leg support; the leg support may comprise a leg extender; the nose may be configured to move with the leg extender; the shape of the nose may comprise a rounded shape. The support member may be configured to provide a form; the support member may be configured to deform under load and to return to a form; the form may comprise a default form; the form may comprise a curved form; the form deflects into a shape under load; the form may be configured to conform to input from an occupant; the form may be configured to conform to task from occupant; the form may comprise a default state of curvature; the support member may be configured to be put into tension under load; the support member may comprise a curved form at installation; the support member may be configured to provide a contour form in response to input from an occupant. The support member may comprise a bridge between a frame of the seat base and the linkage; the linkage may comprise a pivot point and/or a set of pivot points; the linkage may comprise a free pivot point and/or a set of free pivot points; the linkage may comprise a gear at a pivot point; the linkage may comprise a geared pivot point and/or a gear; the frame of the seat base may be configured to provide a stop for the leg support; a nose at the frame of the seat base may be configured to provide a stop for the leg support.

The present invention relates to a seat assembly for a vehicle interior comprising a base and a seat coupled to the base; the seat may comprise a seat base and a seat back; the seat may be configured to be movable relative to the base; the seat back may be configured to be movable relative to the seat base; the seat base may comprise a seat base frame and a leg support; the leg support may comprise a support member configured to provide a support for a leg of an occupant of the seat; the leg support is coupled to a leg support mechanism; the leg support mechanism may comprise a linkage coupled to the support member of the leg support; the leg support mechanism is connected to the seat base frame; the leg support mechanism may be configured to facilitate movement of the leg support between a retracted position and an extended position; the support member may comprise a support plate and/or a support panel and/or a sheet member. The leg support may comprise a movable leg support.

The present invention relates to a component for a vehicle interior comprising a seat assembly comprising a base and a seat comprising a seat base and a seat back; the seat base may comprise a seat cushion; seat base may be configured for movement relative to the base; the seat back may be configured for movement relative to the seat base. The seat base may comprise a leg support and a leg support mechanism; the leg support mechanism may comprise a linkage; leg support may comprise a support member coupled to the linkage; the support member may be configured to provide for movement; movement of the support member may comprise deflection and/or extension and/or retraction. The support member may comprise a support panel configured to bend and/or contour and/or deform. The support panel may comprise a sheet member. The seat may be configured to move between a raised state, a default state, a lowered state and a recumbent state. The present invention relates to a component for a vehicle interior comprising a seat assembly comprising a base and a seat comprising a seat base and a seat back; the seat base may comprise a seat cushion; seat base may be configured for movement relative to the base; the seat back may be configured for movement relative to the seat base; the seat base may comprise a leg support and a leg support mechanism. The leg support mechanism may comprise a linkage; the leg support may comprise a support member coupled to the linkage. The seat may be configured to move between a raised state, a default/nominal state, a lowered state and a recumbent state.

The present invention relates to a seat assembly for a vehicle interior comprising a base and a seat coupled to the base; the seat may comprise a seat base and a seat back; the seat may be configured to be movable relative to the base; the seat back may be configured to be movable relative to the seat base; the seat base may comprise a leg support; the leg support is coupled to a leg support mechanism. The leg support may comprise a movable leg support. The seat base may be configured to be movable relative to the base. The seat base may be configured to be movable with the seat relative to the base. The seat base is coupled to the base. The seat back is coupled to the seat base. The leg support mechanism may comprise a linkage and a support. The support may comprise a support plate. The support plate may comprise a curved plate. The support plate may comprise sheet steel. The support plate may comprise pre-stressed sheet steel. The support plate may comprise spring steel. The support plate may comprise a spring steel plate. The linkage may comprise a base link and a connector link. The support is connected to the connector link. The linkage may comprise a linkage assembly. The linkage assembly may comprise a set of base links and a set of connector links. The linkage assembly may comprise a cross-beam structure and a set of base links and a set of connector links. The leg support mechanism may be configured to provide for movement of the support. The leg support mechanism may be configured to provide for movement of the support between an extended position and a retracted position. The movement of the support may comprise deflection. The seat base may comprise a seat base frame. The leg support mechanism is connected to the seat base frame. The support of the leg support mechanism is connected to the seat base frame. The support may comprise sheet member connected to the seat base frame. The support may comprise sheet member connected to the seat base frame and to a connector link of a linkage of the leg support mechanism. A support of the leg support may comprise a sheet member connected between the seat base frame and a linkage of the leg support mechanism. The support may comprise a sheet member connected between the seat base frame a connector link of the linkage of the leg support mechanism. The movement of the support may comprise deflection under a load. The movement of the support may comprise deflection under a load from an occupant in the seat base. The deflection under a load may comprise flattening of the support. The extension of the leg support may comprise flattening of the support. The extension of the leg support may comprise flattening of the support and extension of the linkage. The extension of the leg support may comprise flattening of the support and extension of the linkage from the seat base frame. The retraction of the leg support may comprise curving of the support. The retraction of the leg support may comprise curving of the support and retraction of the linkage. The retraction of the leg support may comprise curving of the support and retraction of the linkage into the seat base frame. The support may provide a front of the seat base. The front may comprise a curved front. The front is extended when the seat base is extended. The front is retracted when the seat base is retracted. The front is deflected when the seat base is under a load. The front may comprise a nose for the seat base. The seat base may comprise a cushion pad. The seat back may comprise a cushion. The seat may comprise a cover. The seat back may comprise a seat back mechanism. The seat back mechanism may comprise a slide mechanism. The seat back mechanism may comprise a gear mechanism. The seat back mechanism may comprise a slide-gear mechanism. The base for the seat may be configured to be mounted into the vehicle interior. The seat may be configured to move to provide a raised state, a default state, a lowered state and a recumbent state for an occupant. The seat may be configured to move continuously from the raised state to the lowered state through the default state. The assembly may comprise an operator control configured to move the seat back and the seat together. The seat may be configured to move continuously from the raised state to the default state to the lowered state to the recumbent state. The seat back may be configured to move to provide an upright position for the raised state and to provide a lounge position for the recumbent state and to provide a reclined position for the default state. The seat back may comprise a back frame configured to rotate relative the seat base. The assembly may comprise a recliner mechanism configured to move the seat back. The recliner mechanism may comprise an arm may be configured to (a) pivot about the seat back and (b) pivot about the seat base. The seat back may comprise a back frame comprising a first side and a second side; the recliner mechanism may comprise a motor coupled to the first side of the seat back frame. The recliner mechanism may comprise a sector; the motor may be configured to rotate the sector to move the seat back. The sector is coupled to the seat base. The motor may comprise a gear; the sector may comprise a set of teeth may be configured to mesh with the gear of the motor to guide movement of the seat back relative to the seat base. The recliner mechanism may comprise a drive tube coupled to the sector and the second side of the seat back frame, the drive tube may be configured to align movement of the first side of the seat back frame and the second side of the seat back frame. The recliner mechanism may comprise an arm coupled to the drive tube and the seat back frame at a pivot joint. The arm is coupled to the seat base at a pivot joint. The recliner mechanism may comprise an arm configured (a) to couple the drive tube to the seat base and (b) to couple the seat back frame to the seat base. The seat base may comprise a bracket coupled to the recliner mechanism. The bracket may comprise a set of brackets coupled to the recliner mechanism at a set of pivots. The bracket of the set of brackets is coupled to an arm of the recliner mechanism at a pivot joint. The bracket of the set of brackets is coupled to a sector of the recliner mechanism at a pivot joint. The sector may be configured to guide movement of the seat back relative to the seat base. The sector is coupled to a drive tube of the recliner mechanism; the drive tube is coupled to an arm of the recliner mechanism; the arm of the recliner mechanism is coupled to another bracket of the set of brackets at a pivot joint. The seat back may comprise a back frame, a back suspension and a back pad. The seat may be configured to move between a declined position; an inclined position; and a forward position. The assembly may comprise a link mechanism may be configured to move the seat between the declined position; the inclined position; and the forward position. The seat may comprise a seat base frame providing a cushion frame. The seat may comprise a cushion frame, the leg support, and a cushion panel may be configured to bridge between the cushion panel and the leg support. The leg support may comprise a cushion panel. The cushion panel may be configured to tuck the leg support under the cushion frame. The cushion panel may be configured to extend the leg support from the cushion frame. The cushion panel may be configured to change shape to accommodate the occupant. The cushion panel may be configured to flatten under load from the occupant. The leg support may be configured to move from a retracted position to an extended position through a downward position. The seat may comprise a cushion panel may be configured to facilitate movement of the leg support from the retracted position to the extended position through the downward position. The cushion panel may be configured to change shape to facilitate movement of the leg support. The cushion panel may comprise a spring steel panel. The assembly may comprise an extension mechanism may be configured to move the leg support from the retracted position to the extended position through the downward position. The extension mechanism may comprise a 2:1 gear ratio. The extension mechanism may be configured to move the leg support outward from the seat. The extension mechanism may be configured to increase a length of the seat. The assembly may comprise a recline control. The assembly may comprise a tilt control.

The present invention relates to a seat assembly for a vehicle interior comprising a base and a back coupled to the base and a cushion coupled to the base. The assembly may be configured to move between a raised state, a nominal state, a lowered state and a recumbent state. The assembly may be configured to move continuously from the raised state to the lowered state through the nominal state. The assembly may comprise an operator control may be configured to move the back and the cushion together. The assembly may be configured to move continuously from the raised state to the nominal state to the lowered state to the recumbent state. The back may be configured to move from an upright position for the raised state to a lounge position for the recumbent state through a reclined position for the nominal state. The back may comprise a back frame may be configured to rotate relative the base. The assembly may comprise a recliner mechanism may be configured to move the back. The recliner mechanism may comprise an arm may be configured to (a) pivot about the back and (b) pivot about the base. The back may comprise a back frame comprising a first side and a second side; the recliner mechanism may comprise a motor coupled to the first side of the back frame. The recliner mechanism may comprise a sector; the motor may be configured to rotate the sector to move the back. The sector is coupled to the base. The motor may comprise a gear; the sector may comprise a set of teeth may be configured to mesh with the gear of the motor to guide movement of the back relative to the base. The recliner mechanism may comprise a drive tube coupled to the sector and the second side of the back frame; the drive tube may be configured to align movement of the first side of the back frame and the second side of the back frame. The recliner mechanism may comprise an arm coupled to the drive tube and the back frame at a pivot joint. The arm is coupled to the base at a pivot joint. The recliner mechanism may comprise an arm configured (a) to couple the drive tube to the base and (b) to couple the back frame to the base. The base may comprise a bracket coupled to the recliner mechanism. The bracket may comprise a set of brackets coupled to the recliner mechanism at a set of pivots. The bracket of the set of brackets is coupled to an arm of the recliner mechanism at a pivot joint. The bracket of the set of brackets is coupled to a sector of the recliner mechanism at a pivot joint. The sector may be configured to guide movement of the back relative to the base. The sector is coupled to a drive tube of the recliner mechanism; the drive tube is coupled to an arm of the recliner mechanism; the arm of the recliner mechanism is coupled to another bracket of the set of brackets at a pivot joint. The back may comprise a back frame, a back suspension and a back pad. The cushion may be configured to move between a declined position; an inclined position; and a forward position. The assembly may comprise a link mechanism may be configured to move the cushion between the declined position; the inclined position; and the forward position. The assembly may comprise a recline control. The assembly may comprise a tilt control. The assembly may comprise a leg support. The cushion may comprise a cushion frame, the leg support, and a cushion panel may be configured to bridge between the cushion panel and the leg support. The cushion panel may be configured to tuck the leg support under the cushion frame. The cushion panel may be configured to extend the leg support from the cushion frame. The cushion panel may be configured to change shape to accommodate the occupant. The cushion panel may be configured to flatten under load from the occupant. The leg support may be configured to move from a retracted position to an extended position through a downward position. The cushion may comprise a cushion panel may be configured to facilitate movement of the leg support from the retracted position to the extended position through the downward position. The cushion panel may be configured to change shape to facilitate movement of the leg support. The cushion panel may comprise a spring steel panel. The assembly may comprise an extension mechanism may be configured to move the leg support from the retracted position to the extended position through the downward position. The extension mechanism may comprise a 2:1 gear ratio. The extension mechanism may be configured to move the leg support outward from the cushion. The extension mechanism may be configured to increase a length of the cushion.

The present invention relates to a seat for a vehicle interior; the seat may be configured to move between a raised state, a nominal state, a lowered state and a recumbent state for an occupant comprising; the seat may comprise a base; a back coupled to the base; and a cushion coupled to the base.

The present invention relates to a component for a vehicle interior comprising a seat assembly comprising a base and a seat comprising a seat base and a seat back; the seat base may comprise a seat cushion; seat base is configured for movement relative to the base; the seat back is configured for movement relative to the seat base; the seat is may be configured to move between a raised state, a nominal state, a lowered state and a recumbent state; the seat base may comprise a leg support and a leg support mechanism. The nominal state may comprise a default state. The leg support mechanism may comprise a linkage and the leg support may comprise a support plate actuated by the linkage. The support member may comprise a panel or a panel sheet or a curved panel or a stiff panel or a panel member or a spring steel sheet or a tensile element or a biased spring member or a link sheet member or a support panel or a spring member or a spring member coupled to a frame of the seat base and a connector link of the linkage. The leg support may be configured to be actuated by mass and position of an occupant in the seat. The leg support may be configured to provide a floating feel for the occupant in the seat. The leg support may be configured to provide equilibrium for the occupant in the seat. The leg support mechanism may be configured to provide an equilibrium feel by movement in response to actuation and/or mass and position of the occupant. The leg support mechanism may be configured to provide an equilibrium feel by movement of the support plate. The support panel may comprise a support plate and movement of the support panel may comprise deflection and/or extension and/or retraction and/or bending. The leg support mechanism may be configured to provide an equilibrium by movement of the support plate and the linkage. The leg support mechanism may be configured to provide an equilibrium by deflection of the support panel.

The present invention relates to a component for a vehicle interior comprising a seat assembly comprising a base and a seat comprising a seat base and a seat back; the seat base may comprise a seat cushion; seat base may be configured for movement relative to the base; the seat back may be configured for movement relative to the seat base; the seat base may comprise a leg support and a leg support mechanism. The leg support mechanism may comprise a linkage; the leg support may comprise a support member coupled to the linkage. The seat may be configured to move between a raised state, a default state, a lowered state and a recumbent state. The support member may comprise a panel or a panel sheet or a curved panel or a stiff panel or a panel member or a spring steel sheet or a tensile element or a biased spring member or a link sheet member or a support panel or a spring member or a spring member coupled to a frame of the seat base and a connector link of the linkage. The leg support may be configured to be actuated by mass and position of an occupant in the seat; the leg support may be configured to provide a floating feel for the occupant in the seat; the leg support may be configured to provide equilibrium for the occupant in the seat; the leg support mechanism may be configured to provide an equilibrium feel by movement in response to actuation and/or mass and position of the occupant; the leg support mechanism may be configured to provide an equilibrium feel by movement of the support member. The support member may comprise a support plate/panel; movement of the support member plate/panel may comprise deflection and/or extension and/or retraction; the leg support mechanism may be configured to provide an equilibrium by movement of the support member and the linkage; the leg support mechanism may be configured to provide an equilibrium by deflection and/or bending of the support member comprising a panel. The support member may comprise a compliant panel. The support member may be configured to bend and/or contour and/or deform; the support panel may comprise a curvature; the curvature may comprise a default curvature; the curvature may be responsive to an input; the curvature may be reactive to a load from an occupant. The seat base may comprise a nose; the nose may be configured to preserve a shape for the seat base; the shape of the nose may be responsive to a load from occupant; the nose may be configured for movement with the leg support; the nose may be configured to shift with the leg support; the leg support may comprise a leg extender; the nose may be configured to move with the leg extender; the shape of the nose may comprise a rounded shape. The support member may be configured to provide a form; the support member may be configured to deform under load and to return to a form; the form may comprise a default form; the form may comprise a curved form; the form deflects into a shape under load; the form may be configured to conform to input from an occupant; the form may be configured to conform to task from occupant; the form may comprise a default state of curvature; the support member may be configured to be put into tension under load; the support member may comprise a curved form at installation; the support member may be configured to provide a contour form in response to input from an occupant. The support member may comprise a bridge between a frame of the seat base and the linkage. The linkage may comprise a pivot point and/or a set of pivot points; the linkage may comprise a free pivot point and/or a set of free pivot points; the linkage may comprise a gear at a pivot point; the linkage may comprise a geared pivot point; the linkage may comprise a gear. The frame of the seat base may provide a stop for the leg support.

The present invention relates to a seat for a vehicle configured to move between a raised state, a nominal state, a lowered state and a recumbent state for an occupant comprising a base; a back coupled to the base; and a cushion coupled to the base. The seat may be configured to move continuously from the raised state to the lowered state through the nominal state. The seat may comprise an operator control configured to move the back and the cushion together. The seat may be configured to move continuously from the raised state to the nominal state to the lowered state to the recumbent state. The back may be configured to move from an upright position for the raised state to a lounge position for the recumbent state through a reclined position for the nominal state. The back may comprise a back frame configured to rotate relative the base. The seat may comprise a recliner mechanism configured to move the back. The recliner mechanism may comprise an arm configured to (a) pivot about the back and (b) pivot about the base. The back may comprise a back frame comprising a first side and a second side; the recliner mechanism may comprise a motor coupled to the first side of the back frame. The recliner mechanism may comprise a sector; the motor may be configured to rotate the sector to move the back. The sector may be coupled to the base. The motor may comprise a gear; the sector may comprise a set of teeth configured to mesh with the gear of the motor to guide movement of the back relative to the base. The recliner mechanism may comprise a drive tube coupled to the sector and the second side of the back frame; the drive tube may be configured to align movement of the first side of the back frame and the second side of the back frame. The recliner mechanism may comprise an arm coupled to the drive tube and the back frame at a pivot joint. The arm may be coupled to the base at a pivot joint. The recliner mechanism may comprise an arm configured (a) to couple the drive tube to the base and (b) to couple the back frame to the base. The base may comprise a bracket coupled to the recliner mechanism. The bracket may comprise a set of brackets coupled to the recliner mechanism at a set of pivots. A bracket of the set of brackets may be coupled to an arm of the recliner mechanism at a pivot joint. A bracket of the set of brackets may be coupled to a sector of the recliner mechanism at a pivot joint. The sector may be configured to guide movement of the back relative to the base. The sector may be coupled to a drive tube of the recliner mechanism; the drive tube may be coupled to an arm of the recliner mechanism; the arm of the recliner mechanism may be coupled to another bracket of the set of brackets at a pivot joint. The back may comprise a back frame, a back suspension and a back pad. The cushion may be configured to move between a declined position; an inclined position; and a forward position. The seat may comprise a link mechanism configured to move the cushion between the declined position; the inclined position; and the forward position. The seat may comprise a recline control. The seat may comprise a tilt control. The seat may comprise a leg support. The cushion may comprise a cushion frame, the leg support, and a cushion panel configured to bridge between the cushion pan and the leg support. The cushion panel may be configured to tuck the leg support under the cushion frame. The cushion panel may be configured to extend the leg support from the cushion frame. The cushion panel may be configured to change shape to accommodate the occupant. The cushion panel may be configured to flatten under load from the occupant. The leg support may be configured to move from a retracted position to an extended position through a downward position. The cushion may comprise a cushion panel configured to facilitate movement of the leg support from the retracted position to the extended position through the downward position. The cushion panel may be configured to change shape to facilitate movement of the leg support. The cushion panel may comprise a spring steel panel. The seat may comprise an extension mechanism configured to move the leg support from the retracted position to the extended position through the downward position. The extension mechanism may comprise a 2:1 gear ratio. The extension mechanism may be configured to move the leg support outward from the cushion. The extension mechanism may be configured to increase a length of the cushion.

### FIGURES

FIG. 1A is a schematic perspective view of a vehicle according to an exemplary embodiment.

FIG. 1B is a schematic partial perspective view of a vehicle interior according to an exemplary embodiment.

FIG. 2 is a schematic partial perspective view of a vehicle interior according to an exemplary embodiment.

FIGS. 3A through 3C are schematic perspective views of a seat assembly for a vehicle interior according to an exemplary embodiment.

FIGS. 4A through 4E are schematic perspective views of a seat assembly according to an exemplary embodiment.

FIG. 5 is a schematic exploded perspective view of a seat assembly according to an exemplary embodiment.

FIG. 6A is a schematic perspective view of a seat back according to an exemplary embodiment.

FIG. 6B is a schematic exploded perspective view of a seat back according to an exemplary embodiment.

FIG. 7 is a schematic perspective view of a seat base according to an exemplary embodiment.

FIG. 7A is a schematic exploded perspective view of a seat base according to an exemplary embodiment.

FIG. 7B is a schematic exploded perspective view of a support structure of a seat base according to an exemplary embodiment.

FIG. 7C is a schematic side view of a support panel of a seat base according to an exemplary embodiment.

FIGS. 8A and 8B are a schematic exploded perspective views of a mechanism of a seat assembly according to an exemplary embodiment.

FIGS. 9A and 9B are schematic side views of a seat assembly according to an exemplary embodiment.

FIGS. 10A through 10D are schematic detail views of a seat base/mechanism of a seat assembly according to an exemplary embodiment.

FIGS. 11A and 11B are schematic side views of a seat assembly according to an exemplary embodiment.

FIGS. 12A through 12C are schematic detail views of a seat base/mechanism of a seat assembly according to an exemplary embodiment.

FIGS. 13A and 13B are schematic side views of a seat assembly according to an exemplary embodiment.

FIGS. 14A through 14C are schematic side views of a seat assembly according to an exemplary embodiment.

FIGS. 15A through 15E are schematic side views of a seat assembly according to an exemplary embodiment.

FIGS. 16A through 16D are schematic side views of a seat assembly according to an exemplary embodiment.

FIGS. 17A through 17E are schematic side views of a seat assembly according to an exemplary embodiment.

FIGS. 18A through 18C are schematic side views of a seat assembly according to an exemplary embodiment.

FIG. 19 is a schematic perspective view of a frame assembly for a seat assembly according to an exemplary embodiment.

FIGS. 20A and 20B are schematic perspective detail views of a seat base/mechanism of a seat assembly according to an exemplary embodiment.

FIGS. 21A and 21B are schematic perspective detail views of a seat back/mechanism of a seat assembly according to an exemplary embodiment.

FIGS. 22A and 22B are schematic perspective detail views of a seat back/mechanism of a seat assembly according to an exemplary embodiment.

FIGS. 23A and 23B are schematic elevation views of a frame assembly of a seat assembly according to an exemplary embodiment.

### DESCRIPTION

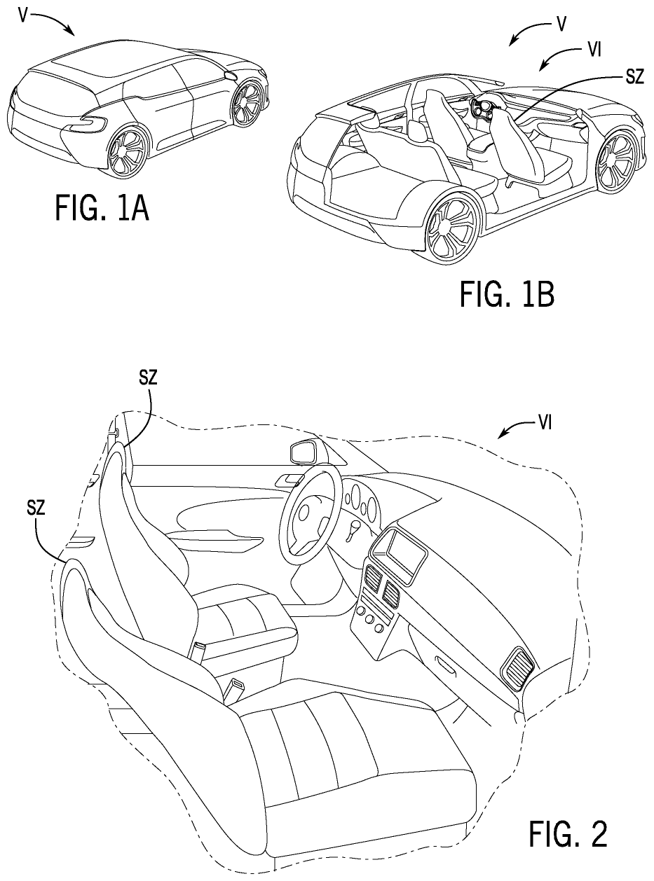

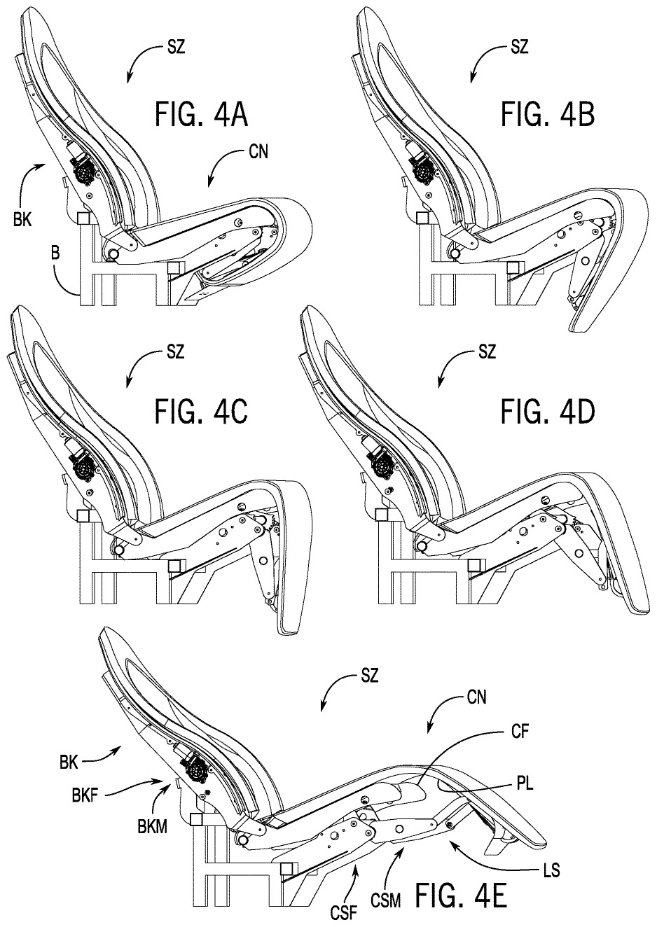

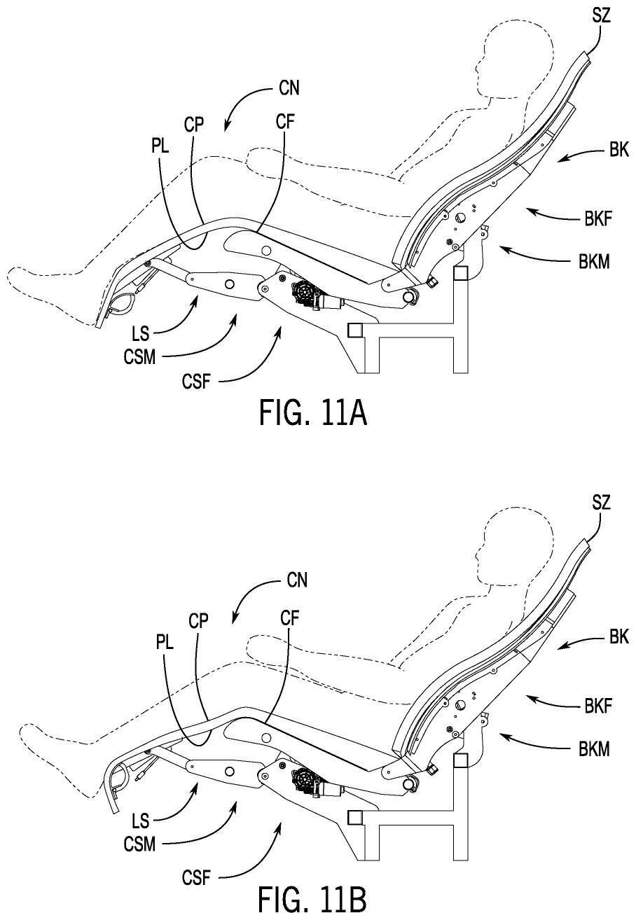

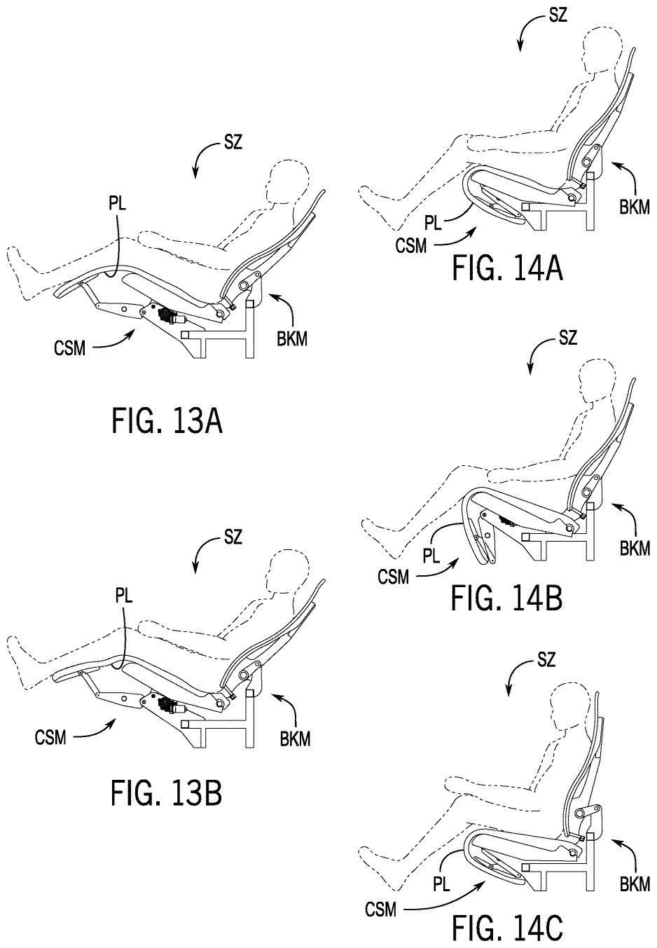

Referring to FIGS. 1A-1B and 2, a vehicle V is shown with an interior VI comprising components such as seat assembly SZ according to an exemplary embodiment. According to an exemplary embodiment shown schematically in FIGS. 2, 3A-3C, 4A-4E, 9A-9B, 11A-11B, 13A-13B, 14A-14C 15A-15E, 16A-16D, 17A-17E, 18A-18C and 19, the seat/assembly SZ may be configured to move for convenient/comfortable use by an occupant of the vehicle interior to a variety of positions/states including between a raised state, a nominal/default state, a lowered state and a recumbent state. See also TABLES A, B, C and D.

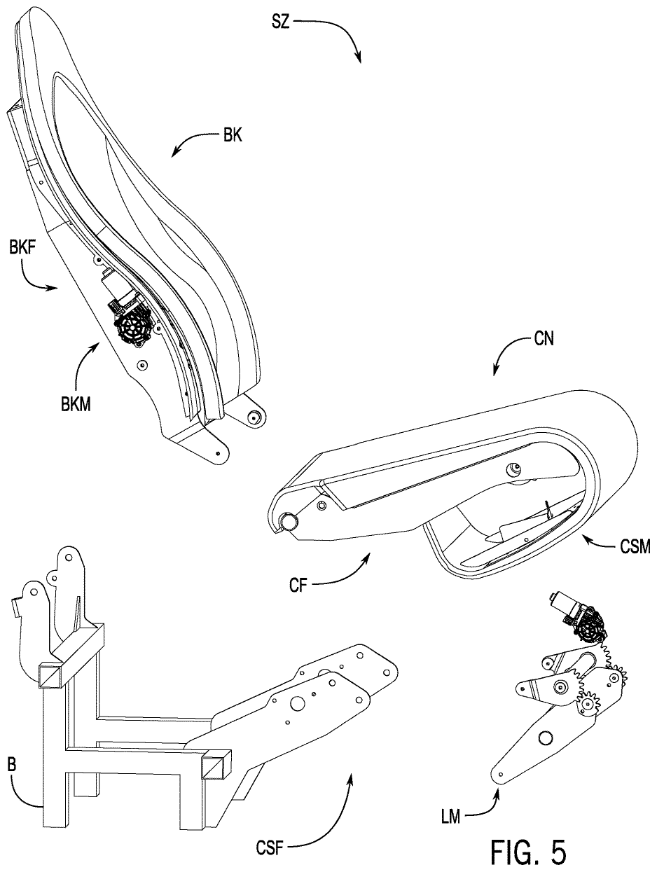

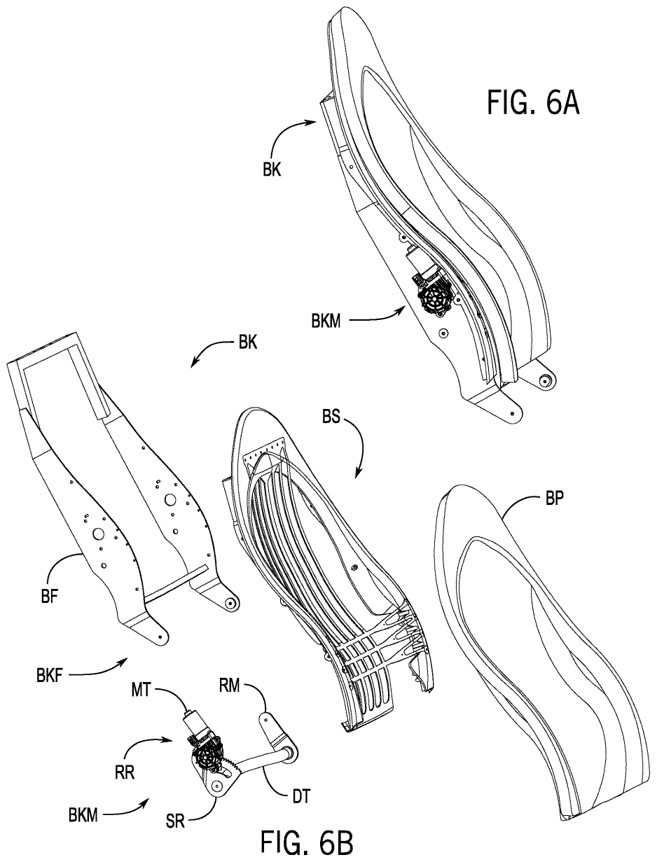

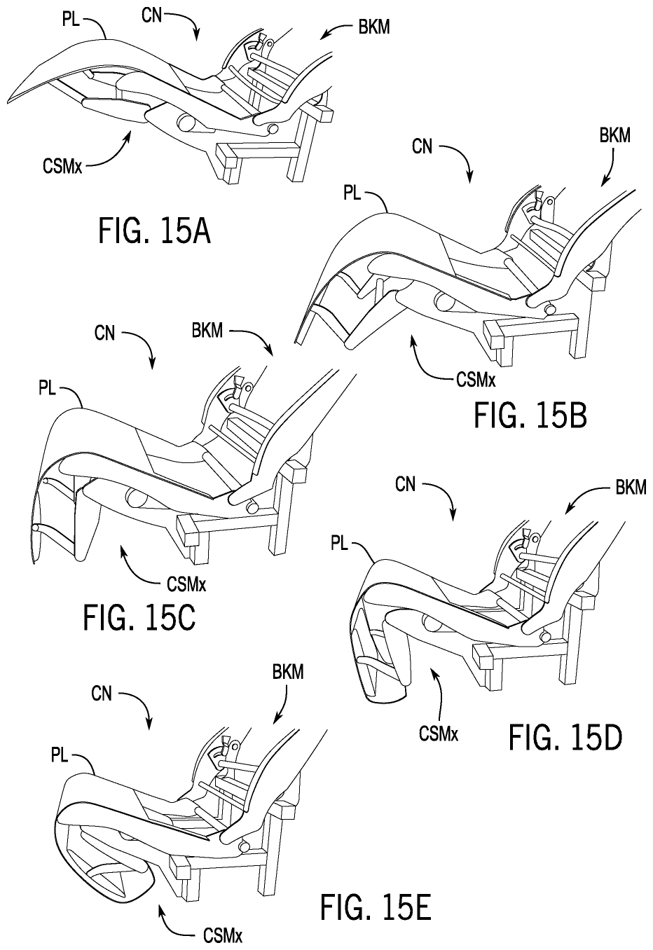

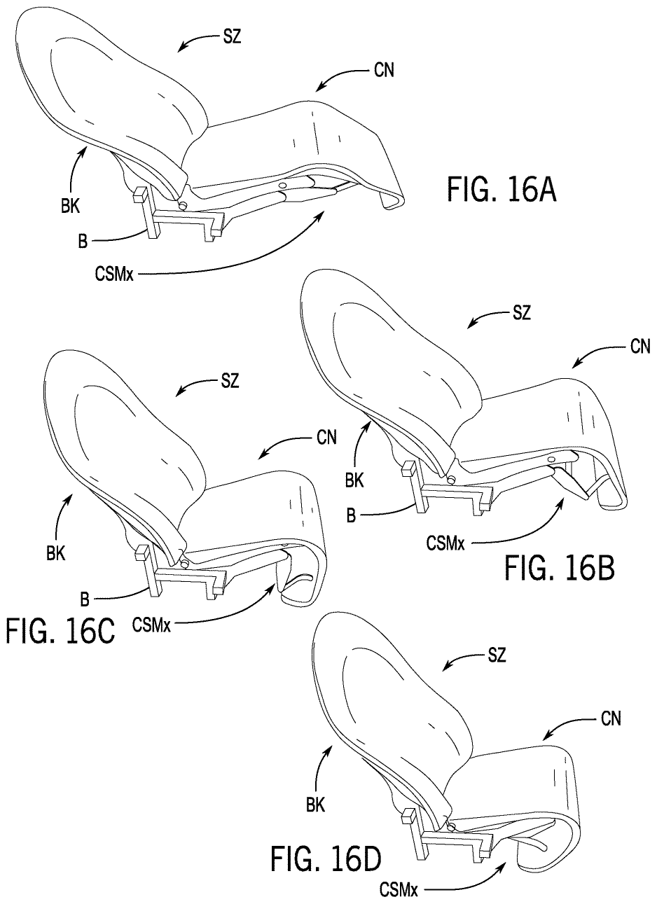

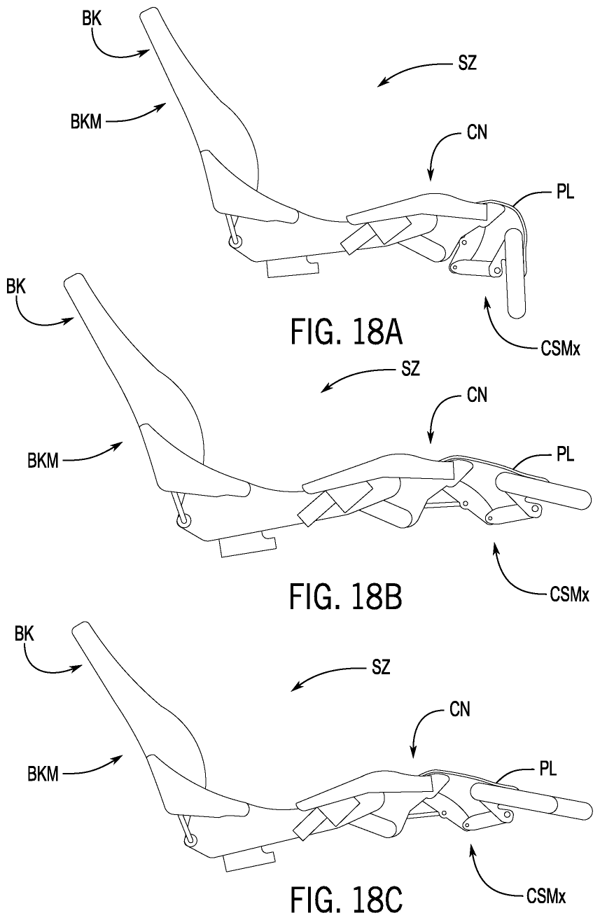

As shown schematically in FIGS. 2, 3A-3C, 4A-4E, 5, 6A-6B, 7, 7A-7C, 9A-9B, 11A-11B, 13A-13B and 14A-14C, seat assembly SZ may comprise a base B shown as a mounting frame; and seat/assembly SZ may comprise a seat base/assembly CN and a seat back/assembly BK; the seat base CN may comprise a seat cushion CP; seat base CN may be configured for movement relative to the base B; the seat back BK may be configured for movement relative to the seat base CN; the seat base CN may comprise a leg support LS and a leg support mechanism CSM. See also FIGS. 15A-15E, 16A-16D, 17A-17E, and 18A-18C.

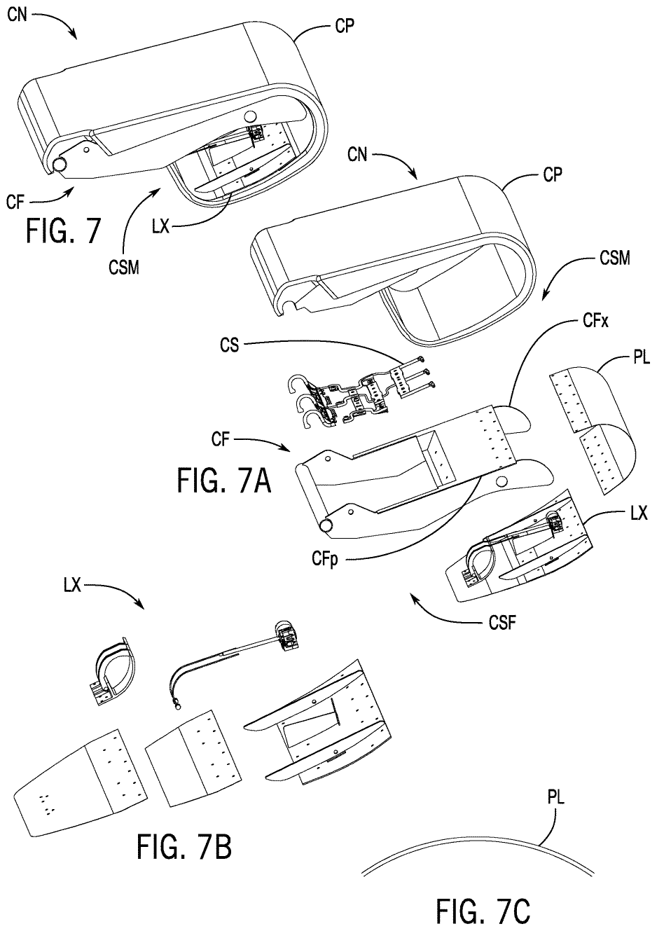

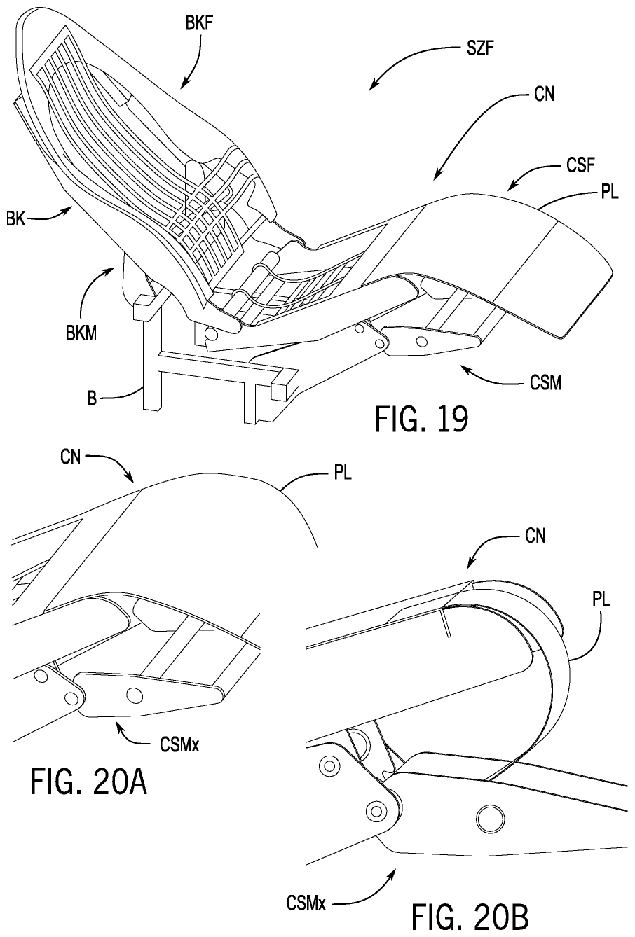

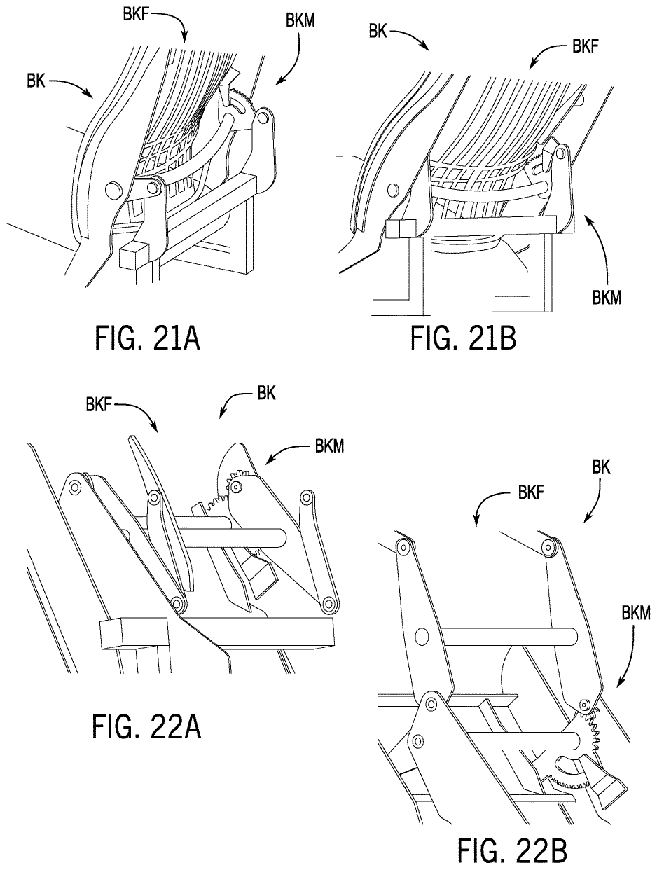

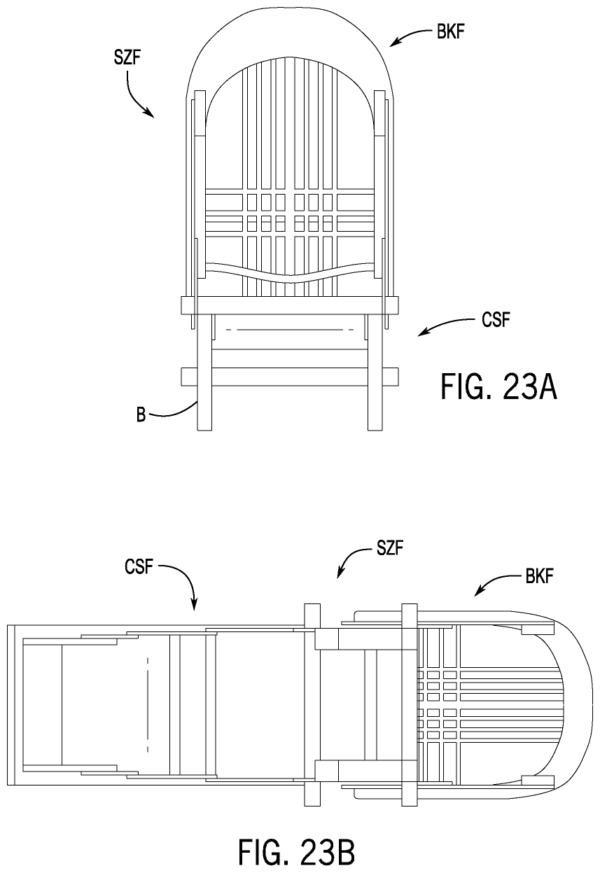

According to an exemplary embodiment as shown schematically in FIGS. 7, 7A-7B, 10A-10D and 12A-12C, the leg support mechanism CSM may comprise a linkage LS and a leg support/member PL; the leg support/member PL may be coupled to the linkage LS; the support member PL may comprise a compliant panel; the support member may be configured to bend and/or contour and/or deform; the support panel may comprise a curvature; the curvature may comprise a default curvature; the curvature may be responsive to an input; the curvature may be reactive to a load from an occupant. See also FIGS. 2, 3A-3C, 4A-4E, 6A-6B, 9A-9B, 11A-11B, 13A-13B and 14A-14C. As indicated schematically in FIGS. 7, 7A-7C, 10A-10D and 12A-12C, the support member PL may comprise a panel or a panel sheet or a curved panel or a stiff panel or a panel member or a spring steel sheet or a tensile element or a biased spring member or a link sheet member or a support panel or a spring member or a spring member coupled to a frame CF of the seat base and a connector link LSb of the linkage LS of the leg support mechanism CSM. See also FIGS. 2, 3A-3C, 4A-4E, 6A-6B, 9A-9B, 11A-11B, 13A-13B and 14A-14C. As indicated schematically, the support/member PL may comprise as a support plate or support panel; the support plate may comprise a curved plate; the support plate may comprise sheet steel; the support plate may comprise pre-stressed sheet steel; the support plate may comprise spring steel; the support plate may comprise a spring steel plate. As indicated schematically in FIGS. 7, 7A-7C, 10A-10D, 11A-11B, 12A-12C, 13A-13B and 14A-14C, the linkage LS of the leg support mechanism CSM for seat base CN may comprise a base link LSa and a connector link LSb; the support/member PL may be connected to the connector link LSb; the linkage LS may comprise a linkage assembly; the linkage assembly LS may comprise a set of base links and a set of connector links; the linkage assembly may comprise a cross beam structure and a set of base links and a set of connector links; the support member PL may comprise a bridge/link between a frame/assembly CF/CSF of the seat base CN and the linkage LS; the nose/frame CFx of the seat base CN may provide a stop for the leg support LS. See also FIGS. 19, 20A-20B and 23A-23B.

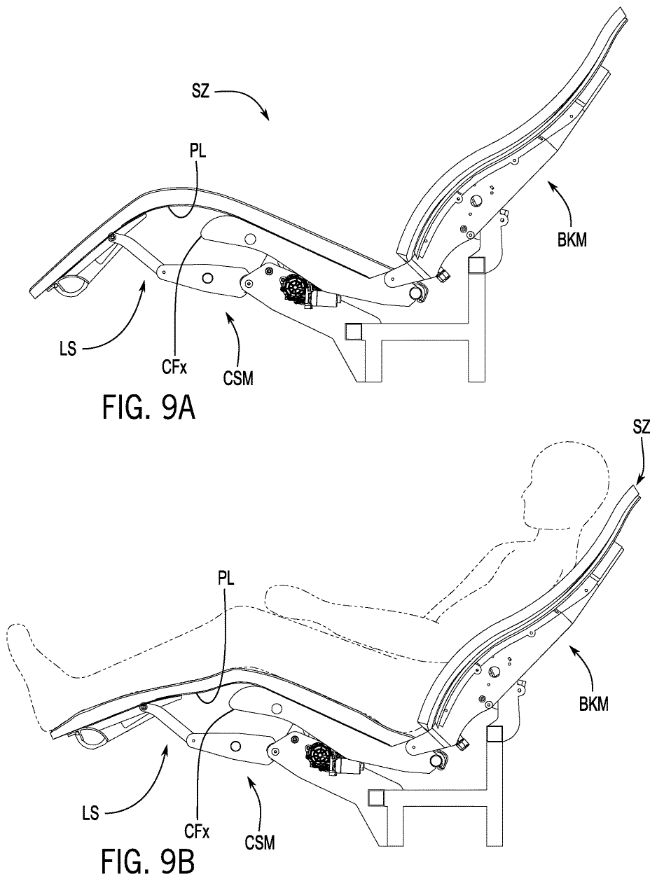

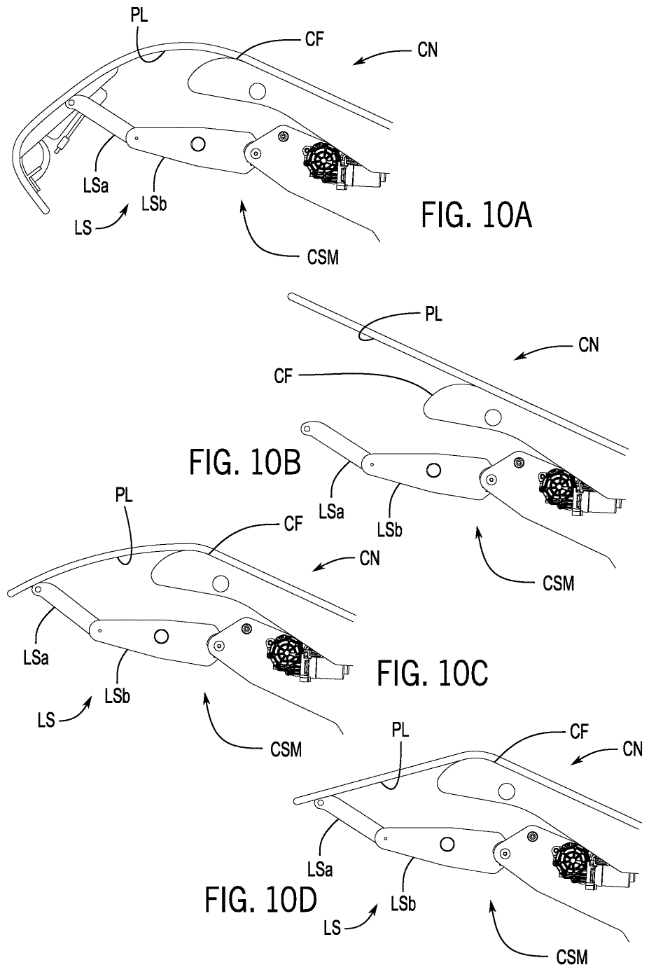

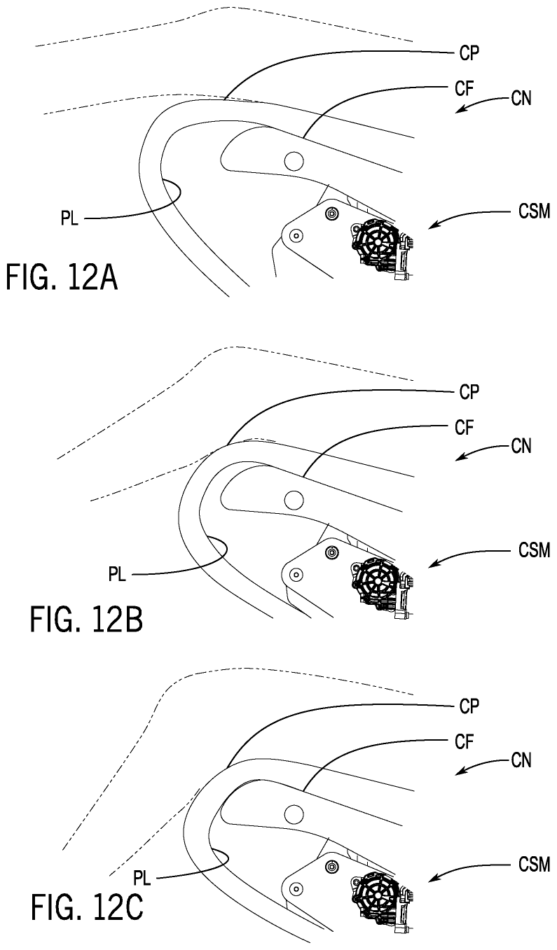

According to an exemplary embodiment as shown schematically in FIGS. 7, 7A-7B, 9A-9B, 10A-10D and 12A-12C, the frame CF of the seat base CN may comprise a nose/front CFx and a panel/plate CFp to support a pad/cushion CP; the nose CFx may be configured to preserve a shape for the seat base CN (e.g. at front/top); the shape of the nose may be responsive to a load from occupant; the nose may be configured for movement with the leg support; the nose may be configured to shift with the leg support; the leg support may comprise a leg extender; the nose may be configured to move with the leg extender; the shape of the nose may comprise a rounded shape. As indicated schematically, the support member PL may be configured to provide a form; the support member may be configured to deform/shift under load and to return to a form; the form may comprise a default form; the form may comprise a curved form; the form may deflect into a shape under load; the form may be configured to conform to input from an occupant; the form may be configured to conform to task from occupant; the form may comprise a default state of curvature. As indicated schematically in FIGS. 10A-10D, the support member PL may be configured to be put into tension under load; the support member may comprise a flat form provided into a curved form at installation; the support member may be configured to provide a contour form in response to input from an occupant. See FIGS. 9A-9B, 11A-11B and 12A-12C. As indicated schematically in FIGS. 7, 7A-7C, 9A-9B, 10A-10D and 11A-11B, the support member PL may comprise a bridge between a frame CF of the seat base CN and the linkage LS. As indicated schematically, the linkage/assembly LS may comprise a pivot point and/or a set of pivot points; the linkage may comprise a free pivot point and/or a set of free pivot points; the linkage may comprise a gear at a pivot point; the linkage may comprise a geared pivot point; the linkage may comprise a gear. As indicated schematically in FIGS. 10A-10D and 12A-12C, the nose/frame CFx of the seat base CN may provide a stop for the leg support LS. See also FIGS. 7, 7A-7B, 9A-9B, 11A-11B, 13A-13B and 14A-14C.

According to an exemplary embodiment as shown schematically in FIGS. 7, 7A-7C, 9A-9B, 10A-10D and 12A-12C, a seat assembly SZ for a vehicle interior may comprise a base and a seat coupled to the base B; the seat may comprise a seat base CN and a seat back BK; the seat may be configured to be movable relative to the base B; the seat back BK may be configured to be movable relative to the seat base CN; the seat base CN may comprise a leg support LS with support member PL; the leg support LS may be coupled to a leg support mechanism CSM. As indicated schematically, the leg support may comprise a movable leg support; the leg support may be configured to be actuated by the leg support mechanism CSM. As indicated schematically in FIGS. 9A-9B, 11A-11B, 13A-13B and 14A-14C, the seat base CN may be configured to be movable relative to the base B; the seat base CN may be configured to be movable with the seat SZ relative to the base B; the seat base CN may be coupled to the base B; the seat back BK may be coupled to the seat base CN. As indicated schematically in FIGS. 7, 7A-7B and 10A-10D, the leg support mechanism CSM may comprise a linkage LS with base link LSa and connector link LSb and support/support member PL.

According to an exemplary embodiment as shown schematically in FIGS. 7, 7A-7C, 9A-9B, 10A-10D and 12A-12C, the leg support mechanism CSM may be configured to be attached at the linkage/mechanism LS and the frame CF of the seat base CN to provide for movement of the support/member PL; the leg support mechanism CSM may be configured to provide for movement of the support/member PL between an extended position and a retracted position. As indicated schematically in FIGS. 9A-9B, 10A-10D and 12A-12C, movement of the support/member PL of seat base CN may comprise deflection and/or bending; movement of the support may comprise deflection under a load; movement of the support/member PL may comprise deflection under a load from an occupant in the seat base CN; deflection under a load may comprise deforming/flattening of the support PL; extension of the leg support/mechanism CSM may comprise deforming/flattening of the support PL; extension of the leg support of the seat base CN may comprise deforming/flattening of the support PL and extension of the linkage LS; extension of the leg support may comprise deforming/flattening of the support PL and extension of the linkage LS from the frame CF/CSF of the seat base CN; retraction of the leg support may comprise deforming/curving of the support PL; retraction of the leg support may comprise deforming/curving of the support PL and retraction of the linkage LS; retraction of the leg support may comprise deforming/curving of the support PL and retraction of the linkage LS into the frame CF/CSF of the seat base CN. See also FIGS. 2, 3A-3C, 4A-4E, 11A-11B, 13A-13B and 14A-14C.

According to an exemplary embodiment as shown schematically in FIGS. 2, 3A-3C, 4A-4E, 9A-9B, 11A-11B, 13A-13B, 14A-14C 15A-15E, 16A-16D, 17A-17E, 18A-18C and 19, the leg support/mechanism LS/CSM of the seat base CS may be configured to be actuated by mass and position of an occupant in the seat SZ; the leg support may be configured to provide a floating feel for the occupant in the seat; the leg support may be configured to provide equilibrium for the occupant in the seat; the leg support mechanism may be configured to provide an equilibrium feel by movement in response to actuation and/or mass and position of the occupant; the leg support mechanism CSM may be configured to provide an equilibrium feel by movement of the support member PL. As indicated schematically, the support member PL may comprise a support plate/panel; movement of the support member plate/panel may comprise deflection and/or extension and/or retraction; the leg support mechanism CSM may be configured to provide an equilibrium by movement of the support member and the linkage LS; the leg support mechanism CSM may be configured to provide an equilibrium by deflection and/or bending of the support member comprising a panel.

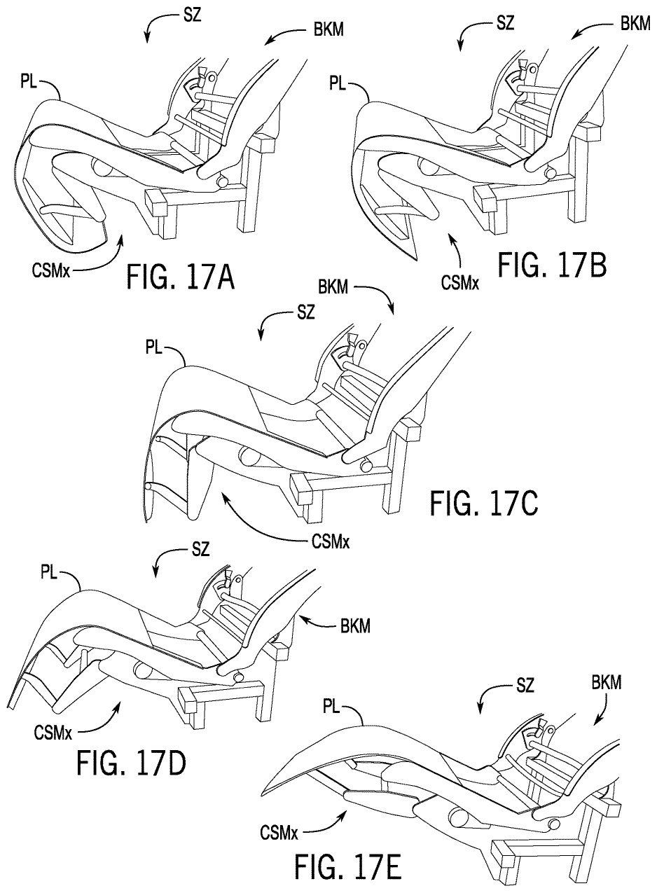

As indicated schematically in FIGS. 2, 3A-3C, 4A-4E, 5, 6A-6B, 15A-15E. 19, 21A-21B, 22A-22B and 23A-23B, the seat/assembly SZ with mounting/base B may comprise a seat assembly frame SZF comprising a seat back frame BF/BKF with seat back mechanism BKM for seat back BK and the seat base frame CSF with seat base mechanism CSMx comprising support/member PL for seat base CN. See also FIGS. 17A-17E, 18A-18C, 19, 20A-20B

### Exemplary Embodiments—A

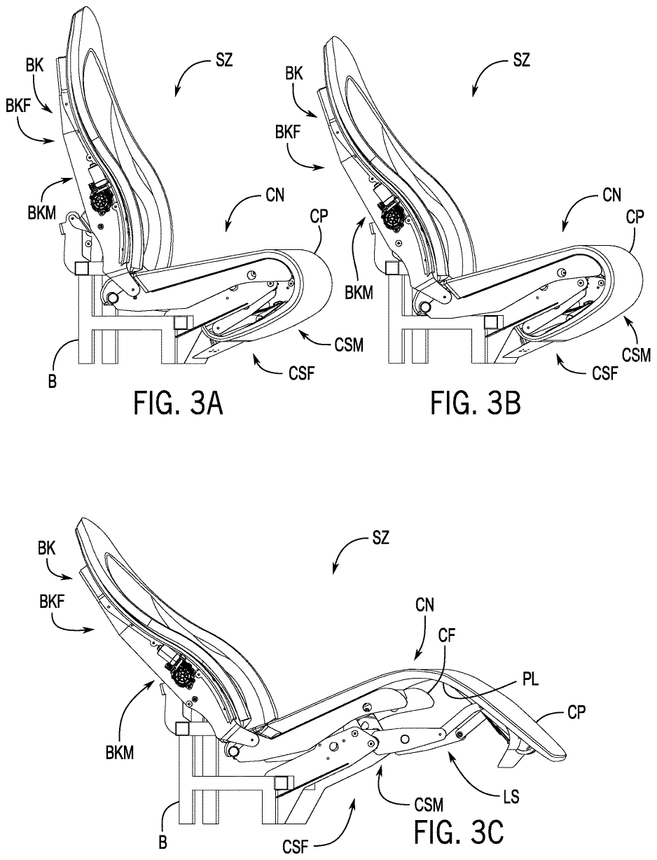

Referring to FIGS. 1A and 1B, a vehicle Vis shown with an interior I comprising components including a seat SZ; as indicated schematically, seat SZ may be configured to fit in a row of seats within the vehicle interior and to be movable for convenient/comfortable use by an occupant of the vehicle interior. See FIGS. 3A-3C, 4A-4E, 9A-9B, 11A-11B, 13A-13B, 14A-14C 15A-15E, 16A-16D, 17A-17E, and 18A-18C. See also TABLES A, B, C and D.

According to an exemplary embodiment shown schematically in FIGS. 2, 3A-3C, 4A-4E, 5, 6A-6B, 7, 7A-7C, 9A-9B, 10A-10D, 11A-11B, 12A-12C, 11A-11B, 13A-13B, 14A-14C, 18A-18C and 19, a component for a vehicle interior may comprise a seat assembly comprising a base and a seat comprising a seat base and a seat back; the seat base may comprise a seat cushion; seat base may be configured for movement relative to the base; the seat back may be configured for movement relative to the seat base; the seat base may comprise a leg support and a leg support mechanism. The leg support mechanism may comprise a linkage; the leg support may comprise a support member coupled to the linkage. The seat may be configured to move between a raised state, a default state, a lowered state and a recumbent state. The support member may comprise a panel or a panel sheet or a curved panel or a stiff panel or a panel member or a spring steel sheet or a tensile element or a biased spring member or a link sheet member or a support panel or a spring member or a spring member coupled to a frame of the seat base and a connector link of the linkage. The leg support may be configured to be actuated by mass and position of an occupant in the seat; the leg support may be configured to provide a floating feel for the occupant in the seat; the leg support may be configured to provide equilibrium for the occupant in the seat; the leg support mechanism may be configured to provide an equilibrium feel by movement in response to actuation and/or mass and position of the occupant; the leg support mechanism may be configured to provide an equilibrium feel by movement of the support member. The support member may comprise a support plate/panel; movement of the support member plate/panel may comprise deflection and/or extension and/or retraction; the leg support mechanism may be configured to provide an equilibrium by movement of the support member and the linkage; the leg support mechanism may be configured to provide an equilibrium by deflection and/or bending of the support member comprising a panel. The support member may comprise a compliant panel. The support member may be configured to bend and/or contour and/or deform; the support panel may comprise a curvature; the curvature may comprise a default curvature; the curvature may be responsive to an input; the curvature may be reactive to a load from an occupant. The seat base may comprise a nose; the nose may be configured to preserve a shape for the seat base; the shape of the nose may be responsive to a load from occupant; the nose may be configured for movement with the leg support; the nose may be configured to shift with the leg support; the leg support may comprise a leg extender; the nose may be configured to move with the leg extender; the shape of the nose may comprise a rounded shape. The support member may be configured to provide a form; the support member may be configured to deform under load and to return to a form; the form may comprise a default form; the form may comprise a curved form; the form deflects into a shape under load; the form may be configured to conform to input from an occupant; the form may be configured to conform to task from occupant; the form may comprise a default state of curvature; the support member may be configured to be put into tension under load; the support member may comprise a curved form at installation; the support member may be configured to provide a contour form in response to input from an occupant. The support member may comprise a bridge between a frame of the seat base and the linkage. The linkage may comprise a pivot point and/or a set of pivot points; the linkage may comprise a free pivot point and/or a set of free pivot points; the linkage may comprise a gear at a pivot point; the linkage may comprise a geared pivot point; the linkage may comprise a gear. The frame of the seat base may provide a stop for the leg support.

According to an exemplary embodiment shown schematically in FIGS. 2, 3A-3C, 4A-4E, 5, 6A-6B, 7, 7A-7C, 9A-9B, 10A-10D, 11A-11B, 12A-12C, 11A-11B, 13A-13B, 14A-14C, 18A-18C and 19, a seat assembly for a vehicle interior may comprise a base and a seat coupled to the base; the seat may comprise a seat base and a seat back; the seat may be configured to be movable relative to the base; the seat back may be configured to be movable relative to the seat base; the seat base may comprise a leg support; the leg support is coupled to a leg support mechanism. The leg support may comprise a movable leg support. The seat base may be configured to be movable relative to the base. The seat base may be configured to be movable with the seat relative to the base. The seat base is coupled to the base. The seat back is coupled to the seat base. The leg support mechanism may comprise a linkage and a support. The support may comprise a support plate. The support plate may comprise a curved plate. The support plate may comprise sheet steel. The support plate may comprise pre-stressed sheet steel. The support plate may comprise spring steel. The support plate may comprise a spring steel plate. The linkage may comprise a base link and a connector link. The support is connected to the connector link. The linkage may comprise a linkage assembly. The linkage assembly may comprise a set of base links and a set of connector links. The linkage assembly may comprise a cross-beam structure and a set of base links and a set of connector links. The leg support mechanism may be configured to provide for movement of the support. The leg support mechanism may be configured to provide for movement of the support between an extended position and a retracted position. The movement of the support may comprise deflection. The seat base may comprise a seat base frame. The leg support mechanism is connected to the seat base frame. The support of the leg support mechanism is connected to the seat base frame. The support may comprise sheet member connected to the seat base frame. The support may comprise sheet member connected to the seat base frame and to a connector link of a linkage of the leg support mechanism. A support of the leg support may comprise a sheet member connected between the seat base frame and a linkage of the leg support mechanism. The support may comprise a sheet member connected between the seat base frame a connector link of the linkage of the leg support mechanism. The movement of the support may comprise deflection under a load. The movement of the support may comprise deflection under a load from an occupant in the seat base. The deflection under a load may comprise flattening of the support. The extension of the leg support may comprise flattening of the support. The extension of the leg support may comprise flattening of the support and extension of the linkage. The extension of the leg support may comprise flattening of the support and extension of the linkage from the seat base frame. The retraction of the leg support may comprise curving of the support. The retraction of the leg support may comprise curving of the support and retraction of the linkage. The retraction of the leg support may comprise curving of the support and retraction of the linkage into the seat base frame. The support may provide a front of the seat base. The front may comprise a curved front. The front is extended when the seat base is extended. The front is retracted when the seat base is retracted. The front is deflected when the seat base is under a load. The front may comprise a nose for the seat base. The seat base may comprise a cushion pad. The seat back may comprise a cushion. The seat may comprise a cover. The seat back may comprise a seat back mechanism. The seat back mechanism may comprise a slide mechanism. The seat back mechanism may comprise a gear mechanism. The seat back mechanism may comprise a slide-gear mechanism. The base for the seat may be configured to be mounted into the vehicle interior. The seat may be configured to move to provide a raised state, a default state, a lowered state and a recumbent state for an occupant. The seat may be configured to move continuously from the raised state to the lowered state through the default state. The assembly may comprise an operator control configured to move the seat back and the seat together. The seat may be configured to move continuously from the raised state to the default state to the lowered state to the recumbent state. The seat back may be configured to move to provide an upright position for the raised state and to provide a lounge position for the recumbent state and to provide a reclined position for the default state. The seat back may comprise a back frame configured to rotate relative the seat base. The assembly may comprise a recliner mechanism configured to move the seat back. The recliner mechanism may comprise an arm may be configured to (a) pivot about the seat back and (b) pivot about the seat base. The seat back may comprise a back frame comprising a first side and a second side; the recliner mechanism may comprise a motor coupled to the first side of the seat back frame. The recliner mechanism may comprise a sector; the motor may be configured to rotate the sector to move the seat back. The sector is coupled to the seat base. The motor may comprise a gear; the sector may comprise a set of teeth may be configured to mesh with the gear of the motor to guide movement of the seat back relative to the seat base. The recliner mechanism may comprise a drive tube coupled to the sector and the second side of the seat back frame, the drive tube may be configured to align movement of the first side of the seat back frame and the second side of the seat back frame. The recliner mechanism may comprise an arm coupled to the drive tube and the seat back frame at a pivot joint. The arm is coupled to the seat base at a pivot joint. The recliner mechanism may comprise an arm configured (a) to couple the drive tube to the seat base and (b) to couple the seat back frame to the seat base. The seat base may comprise a bracket coupled to the recliner mechanism. The bracket may comprise a set of brackets coupled to the recliner mechanism at a set of pivots. The bracket of the set of brackets is coupled to an arm of the recliner mechanism at a pivot joint. The bracket of the set of brackets is coupled to a sector of the recliner mechanism at a pivot joint. The sector may be configured to guide movement of the seat back relative to the seat base. The sector is coupled to a drive tube of the recliner mechanism; the drive tube is coupled to an arm of the recliner mechanism; the arm of the recliner mechanism is coupled to another bracket of the set of brackets at a pivot joint. The seat back may comprise a back frame, a back suspension and a back pad. The seat may be configured to move between a declined position; an inclined position; and a forward position. The assembly may comprise a link mechanism may be configured to move the seat between the declined position; the inclined position; and the forward position. The seat may comprise a seat base frame providing a cushion frame. The seat may comprise a cushion frame, the leg support, and a cushion panel may be configured to bridge between the cushion panel and the leg support. The leg support may comprise a cushion panel. The cushion panel may be configured to tuck the leg support under the cushion frame. The cushion panel may be configured to extend the leg support from the cushion frame. The cushion panel may be configured to change shape to accommodate the occupant. The cushion panel may be configured to flatten under load from the occupant. The leg support may be configured to move from a retracted position to an extended position through a downward position. The seat may comprise a cushion panel may be configured to facilitate movement of the leg support from the retracted position to the extended position through the downward position. The cushion panel may be configured to change shape to facilitate movement of the leg support. The cushion panel may comprise a spring steel panel. The assembly may comprise an extension mechanism may be configured to move the leg support from the retracted position to the extended position through the downward position. The extension mechanism may comprise a 2:1 gear ratio. The extension mechanism may be configured to move the leg support outward from the seat. The extension mechanism may be configured to increase a length of the seat. The assembly may comprise a recline control. The assembly may comprise a tilt control.

According to an exemplary embodiment shown schematically in FIGS. 2, 3A-3C, 4A-4E, 5, 6A-6B, 7, 7A-7C, 9A-9B, 10A-10D, 11A-11B, 12A-12C, 11A-11B, 13A-13B, 14A-14C, 18A-18C and 19, a seat assembly for a vehicle interior may comprise a base and a back coupled to the base and a cushion coupled to the base. The assembly may be configured to move between a raised state, a nominal state, a lowered state and a recumbent state. The assembly may be configured to move continuously from the raised state to the lowered state through the nominal state. The assembly may comprise an operator control may be configured to move the back and the cushion together. The assembly may be configured to move continuously from the raised state to the nominal state to the lowered state to the recumbent state. The back may be configured to move from an upright position for the raised state to a lounge position for the recumbent state through a reclined position for the nominal state. The back may comprise a back frame may be configured to rotate relative the base. The assembly may comprise a recliner mechanism may be configured to move the back. The recliner mechanism may comprise an arm may be configured to (a) pivot about the back and (b) pivot about the base. The back may comprise a back frame comprising a first side and a second side; the recliner mechanism may comprise a motor coupled to the first side of the back frame. The recliner mechanism may comprise a sector; the motor may be configured to rotate the sector to move the back. The sector is coupled to the base. The motor may comprise a gear; the sector may comprise a set of teeth may be configured to mesh with the gear of the motor to guide movement of the back relative to the base. The recliner mechanism may comprise a drive tube coupled to the sector and the second side of the back frame; the drive tube may be configured to align movement of the first side of the back frame and the second side of the back frame. The recliner mechanism may comprise an arm coupled to the drive tube and the back frame at a pivot joint. The arm is coupled to the base at a pivot joint. The recliner mechanism may comprise an arm configured (a) to couple the drive tube to the base and (b) to couple the back frame to the base. The base may comprise a bracket coupled to the recliner mechanism. The bracket may comprise a set of brackets coupled to the recliner mechanism at a set of pivots. The bracket of the set of brackets is coupled to an arm of the recliner mechanism at a pivot joint. The bracket of the set of brackets is coupled to a sector of the recliner mechanism at a pivot joint. The sector may be configured to guide movement of the back relative to the base. The sector is coupled to a drive tube of the recliner mechanism; the drive tube is coupled to an arm of the recliner mechanism; the arm of the recliner mechanism is coupled to another bracket of the set of brackets at a pivot joint. The back may comprise a back frame, a back suspension and a back pad. The cushion may be configured to move between a declined position; an inclined position; and a forward position. The assembly may comprise a link mechanism may be configured to move the cushion between the declined position; the inclined position; and the forward position. The assembly may comprise a recline control. The assembly may comprise a tilt control. The assembly may comprise a leg support. The cushion may comprise a cushion frame, the leg support, and a cushion panel may be configured to bridge between the cushion panel and the leg support. The cushion panel may be configured to tuck the leg support under the cushion frame. The cushion panel may be configured to extend the leg support from the cushion frame. The cushion panel may be configured to change shape to accommodate the occupant. The cushion panel may be configured to flatten under load from the occupant. The leg support may be configured to move from a retracted position to an extended position through a downward position. The cushion may comprise a cushion panel may be configured to facilitate movement of the leg support from the retracted position to the extended position through the downward position. The cushion panel may be configured to change shape to facilitate movement of the leg support. The cushion panel may comprise a spring steel panel. The assembly may comprise an extension mechanism may be configured to move the leg support from the retracted position to the extended position through the downward position. The extension mechanism may comprise a 2:1 gear ratio. The extension mechanism may be configured to move the leg support outward from the cushion. The extension mechanism may be configured to increase a length of the cushion.

According to an exemplary embodiment shown schematically in FIGS. 2, 3A-3C, 4A-4E, 5, 6A-6B, 7, 7A-7C, 9A-9B, 10A-10D, 11A-11B, 12A-12C, 11A-11B, 13A-13B, 14A-14C, 18A-18C and 19, a component for a vehicle interior may comprise a seat assembly comprising a base and a seat comprising a seat base and a seat back; the seat base may comprise a seat cushion; seat base is configured for movement relative to the base; the seat back is configured for movement relative to the seat base; the seat is may be configured to move between a raised state, a nominal state, a lowered state and a recumbent state; the seat base may comprise a leg support and a leg support mechanism. The nominal state may comprise a default state. The leg support mechanism may comprise a linkage and the leg support may comprise a support plate actuated by the linkage. The support member may comprise a panel or a panel sheet or a curved panel or a stiff panel or a panel member or a spring steel sheet or a tensile element or a biased spring member or a link sheet member or a support panel or a spring member or a spring member coupled to a frame of the seat base and a connector link of the linkage. The leg support may be configured to be actuated by mass and position of an occupant in the seat. The leg support may be configured to provide a floating feel for the occupant in the seat. The leg support may be configured to provide equilibrium for the occupant in the seat. The leg support mechanism may be configured to provide an equilibrium feel by movement in response to actuation and/or mass and position of the occupant. The leg support mechanism may be configured to provide an equilibrium feel by movement of the support plate. The support panel may comprise a support plate and movement of the support panel may comprise deflection and/or extension and/or retraction and/or bending. The leg support mechanism may be configured to provide an equilibrium by movement of the support plate and the linkage. The leg support mechanism may be configured to provide an equilibrium by deflection of the support panel.

According to an exemplary embodiment shown schematically in FIGS. 2, 3A-3C, 4A-4E, 9A-9B, 11A-11B, 13A-13B, 14A-14C 15A-15E, 16A-16D, 17A-17E, 18A-18C and 19, a seat/assembly for a vehicle interior may be configured to move between a raised state, a nominal state, a lowered state and a recumbent state for an occupant; the seat/assembly may comprise a base; a back coupled to the base; and a cushion coupled to the base. See also TABLES A, B, C and D.

According to an exemplary embodiment shown schematically in FIGS. 2, 3A-3C, 4A-4E, 7, 7A-7C, 10A-10D and 12A-12C, a component for a vehicle interior may comprise a seat assembly comprising a mounting/base and a seat comprising a seat base and a seat back; the seat base may comprise a cushion; the seat base may be configured for movement relative to the base; the seat back may be configured for movement relative to the seat base; the seat base may comprise a leg support and a leg support mechanism comprising a linkage; the leg support may comprise a support member coupled to the linkage; the leg support/member may comprise a stiff/compliant panel configured to bend/deform or contour in movement such as to provide an equilibrium effect in reaction/response to an input/load actuation and/or mass and position of the occupant; the leg support/member may comprise a curved/spring panel member. The seat may be configured to move between a raised state, a default/nominal state, a lowered state and a recumbent state. See FIGS. 9A-9B, 11A-11B, 13A-13B, 14A-14C 15A-15E, 16A-16D, 17A-17E, 18A-18C and 19. See also TABLES A, B, C and D.

### Exemplary Embodiments—B

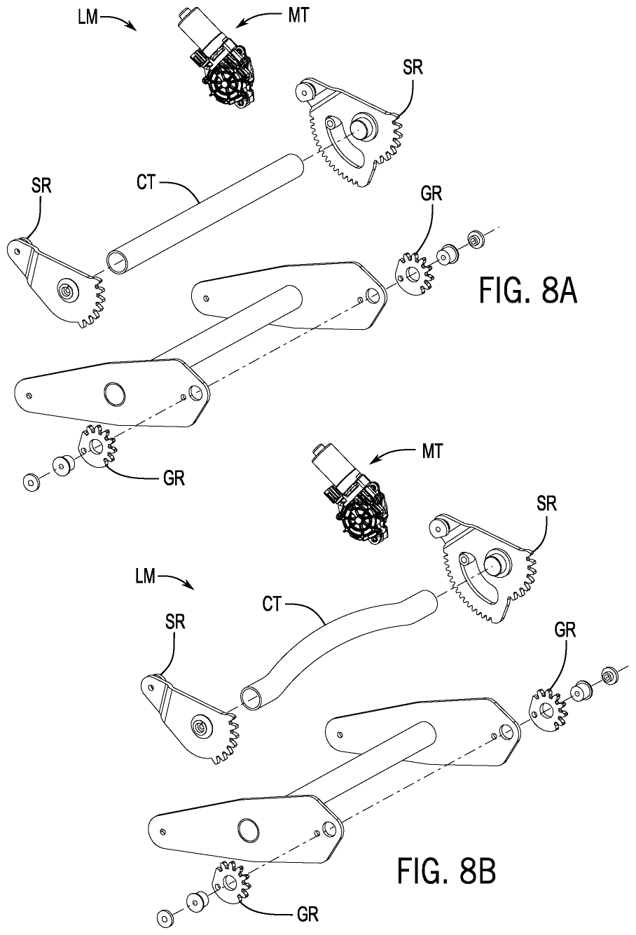

Referring to FIGS. 1A and 1B, a vehicle V is shown with an interior I comprising components including a seat SZ; as indicated schematically, seat SZ may be configured to fit in a row of seats within the vehicle interior; the seat SZ may comprise a back/seat back assembly BK and a cushion/seat cushion assembly CN on a base B; the seat SZ may be movable and/or reconfigurable for use by a vehicle occupant. See FIGS. 2, 3A-3C, 4A-4E, 5, 6A-6B, 7, 7A-7C, 8A-8C, 9A-9B, 10A-10D, 11A-11B, 12A-12C, 13A-13B, 14A-14C 15A-15E, 16A-16D, 17A-17E, 18A-18C, 19, 20A-20B, 21A-21B, 22A-22B and 23A-23B. See also TABLES A, B, C, D and E.

According to an exemplary embodiment as shown schematically in the FIGURES and TABLES, seat SZ may be configured to provide multiple states for vehicle occupants of varying size and/or stature. Seat SZ may be configured to provide a raised state (e.g. for vehicle occupants of short stature). In the raised state, the back may be in an upright position with the leading edge of the cushion in a declined position. Seat SZ may be configured to provide a nominal position (e.g. for vehicle occupants of median stature). In the nominal state, the back may be in a reclined position with the leading edge of the cushion in a mid-position. Seat SZ may be configured to provide a lowered state (e.g. for vehicle occupants of tall stature). In the lowered state, the back may be in an upright position with the leading edge of the cushion in an inclined position. Seat SZ may comprise a recline control and a tilt control. The recline control may be configured to move seat SZ between the raised state and the nominal state. The tilt control may be configured to move seat SZ between the nominal state and the lowered state. Seat SZ may comprise a single control configured to move seat SZ between the raised state, the nominal state and the lowered state. Seat SZ may be configured to provide a recumbent state to accommodate/support a lounging vehicle occupant. In the recumbent state, the back may be in a lounging position with the leading edge of the cushion in a forward position. Seat SZ may comprise a leg support configured to move from a retracted position to an extended position for the recumbent state. The leg support may be configured to move from the retracted position to the extended position through a downward position. Seat SZ may comprise a single control configured to move seat SZ between the raised state, the nominal state, the lowered state and the recumbent state. Movement of the back may drive movement of the cushion. Movement of the cushion may drive movement of the back. The back and the cushion may be configured to move together.

According to an exemplary embodiment as shown schematically in the FIGURES, a seat for a vehicle configured to move between a raised state, a nominal state, a lowered state and a recumbent state for an occupant may comprise a base; a back coupled to the base; and a cushion coupled to the base. The seat may be configured to move continuously from the raised state to the lowered state through the nominal state. The seat may comprise an operator control configured to move the back and the cushion together. The seat may be configured to move continuously from the raised state to the nominal state to the lowered state to the recumbent state. The back may be configured to move from an upright position for the raised state to a lounge position for the recumbent state through a reclined position for the nominal state. The back may comprise a back frame configured to rotate relative the base. The seat may comprise a recliner mechanism configured to move the back. The recliner mechanism may comprise an arm configured to (a) pivot about the back and (b) pivot about the base. The back may comprise a back frame comprising a first side and a second side; the recliner mechanism may comprise a motor coupled to the first side of the back frame. The recliner mechanism may comprise a sector; the motor may be configured to rotate the sector to move the back. The sector may be coupled to the base. The motor may comprise a gear; the sector may comprise a set of teeth configured to mesh with the gear of the motor to guide movement of the back relative to the base. The recliner mechanism may comprise a drive tube coupled to the sector and the second side of the back frame; the drive tube may be configured to align movement of the first side of the back frame and the second side of the back frame. The recliner mechanism may comprise an arm coupled to the drive tube and the back frame at a pivot joint. The arm may be coupled to the base at a pivot joint. The recliner mechanism may comprise an arm configured (a) to couple the drive tube to the base and (b) to couple the back frame to the base. The base may comprise a bracket coupled to the recliner mechanism. The bracket may comprise a set of brackets coupled to the recliner mechanism at a set of pivots. A bracket of the set of brackets may be coupled to an arm of the recliner mechanism at a pivot joint. A bracket of the set of brackets may be coupled to a sector of the recliner mechanism at a pivot joint. The sector may be configured to guide movement of the back relative to the base. The sector may be coupled to a drive tube of the recliner mechanism; the drive tube may be coupled to an arm of the recliner mechanism; the arm of the recliner mechanism may be coupled to another bracket of the set of brackets at a pivot joint. The back may comprise a back frame, a back suspension and a back pad. The cushion may be configured to move between a declined position; an inclined position; and a forward position. The seat may comprise a link mechanism configured to move the cushion between the declined position; the inclined position; and the forward position. The seat may comprise a recline control. The seat may comprise a tilt control. The seat may comprise a leg support. The cushion may comprise a cushion frame, the leg support, and a cushion panel configured to bridge between the cushion pan and the leg support. The cushion panel may be configured to tuck the leg support under the cushion frame. The cushion panel may be configured to extend the leg support from the cushion frame. The cushion panel may be configured to change shape to accommodate the occupant. The cushion panel may be configured to flatten under load from the occupant. The leg support may be configured to move from a retracted position to an extended position through a downward position. The cushion may comprise a cushion panel configured to facilitate movement of the leg support from the retracted position to the extended position through the downward position. The cushion panel may be configured to change shape to facilitate movement of the leg support. The cushion panel may comprise a spring steel panel. The seat may comprise an extension mechanism configured to move the leg support from the retracted position to the extended position through the downward position. The extension mechanism may comprise a 2:1 gear ratio. The extension mechanism may be configured to move the leg support outward from the cushion. The extension mechanism may be configured to increase a length of the cushion.

According to an exemplary embodiment as shown schematically in the FIGURES and TABLES, a seat for a vehicle may be configured to move between a raised state, a nominal state, a lowered state and a recumbent state. The seat may move continuously from the raised state to the lowered state through the nominal state. The seat may comprise a back coupled to a base; and a cushion coupled to the base. The seat may comprise a control to move the back and the cushion together. The seat may move continuously from the raised state to the nominal state to the lowered state to the recumbent state. The seat may comprise a recliner mechanism to move the back. The seat may comprise a link mechanism to move the cushion between a declined position; an inclined position; and a forward position. The cushion may comprise a cushion frame, a leg support, and a cushion panel to tuck the leg support under the cushion frame.

According to an exemplary embodiment as shown schematically in the FIGURES and TABLES, a seating arrangement for a vehicle interior may comprise a seat assembly comprising a base and a seat coupled to the base. The seat may comprise a seat bottom and a seat back each configured for independent movement relative to each other and the base. The seat bottom may comprise a leg support/rest that is actuated by a leg support/rest mechanism and provides adjustable support for the occupant's legs. The seat bottom may be movable relative to the base either independently or together with the seat to facilitate a plurality of seat/seating configurations for an occupant of the vehicle interior. The leg support/rest mechanism may comprise a support and a linkage with a base link and a connector link. The support may comprise sheet member connected to the seat base frame and to the connector link of the linkage of the leg support mechanism.

### Exemplary Embodiments—X

According to an exemplary embodiment as shown schematically in the FIGURES, a component for a vehicle interior may comprise a seat assembly comprising a base and a seat comprising a seat base and a seat back; the seat base may comprise a seat cushion; seat base may be configured for movement relative to the base; the seat back may be configured for movement relative to the seat base; the seat base may comprise a leg support and a leg support mechanism. The leg support mechanism may comprise a linkage; the leg support may comprise a support member coupled to the linkage. The seat may be configured to move between a raised state, a default/nominal state, a lowered state and a recumbent state.

According to an exemplary embodiment as shown schematically in the FIGURES, a seat assembly for a vehicle interior may comprise a base and a seat coupled to the base; the seat may comprise a seat base and a seat back; the seat may be configured to be movable relative to the base; the seat back may be configured to be movable relative to the seat base; the seat base may comprise a leg support; the leg support is coupled to a leg support mechanism. The leg support may comprise a movable leg support. The seat base may be configured to be movable relative to the base. The seat base may be configured to be movable with the seat relative to the base. The seat base is coupled to the base. The seat back is coupled to the seat base. The leg support mechanism may comprise a linkage and a support. The support may comprise a support plate. The support plate may comprise a curved plate. The support plate may comprise sheet steel. The support plate may comprise pre-stressed sheet steel. The support plate may comprise spring steel. The support plate may comprise a spring steel plate. The linkage may comprise a base link and a connector link. The support is connected to the connector link. The linkage may comprise a linkage assembly. The linkage assembly may comprise a set of base links and a set of connector links. The linkage assembly may comprise a cross-beam structure and a set of base links and a set of connector links. The leg support mechanism may be configured to provide for movement of the support. The leg support mechanism may be configured to provide for movement of the support between an extended position and a retracted position. The movement of the support may comprise deflection. The seat base may comprise a seat base frame. The leg support mechanism is connected to the seat base frame. The support of the leg support mechanism is connected to the seat base frame. The support may comprise sheet member connected to the seat base frame. The support may comprise sheet member connected to the seat base frame and to a connector link of a linkage of the leg support mechanism. A support of the leg support may comprise a sheet member connected between the seat base frame and a linkage of the leg support mechanism. The support may comprise a sheet member connected between the seat base frame a connector link of the linkage of the leg support mechanism. The movement of the support may comprise deflection under a load. The movement of the support may comprise deflection under a load from an occupant in the seat base. The deflection under a load may comprise flattening of the support. The extension of the leg support may comprise flattening of the support. The extension of the leg support may comprise flattening of the support and extension of the linkage. The extension of the leg support may comprise flattening of the support and extension of the linkage from the seat base frame. The retraction of the leg support may comprise curving of the support. The retraction of the leg support may comprise curving of the support and retraction of the linkage. The retraction of the leg support may comprise curving of the support and retraction of the linkage into the seat base frame. The support may provide a front of the seat base. The front may comprise a curved front. The front is extended when the seat base is extended. The front is retracted when the seat base is retracted. The front is deflected when the seat base is under a load. The front may comprise a nose for the seat base. The seat base may comprise a cushion pad. The seat back may comprise a cushion. The seat may comprise a cover. The seat back may comprise a seat back mechanism. The seat back mechanism may comprise a slide mechanism. The seat back mechanism may comprise a gear mechanism. The seat back mechanism may comprise a slide-gear mechanism. The base for the seat may be configured to be mounted into the vehicle interior. The seat may be configured to move to provide a raised state, a default state, a lowered state and a recumbent state for an occupant. The seat may be configured to move continuously from the raised state to the lowered state through the default state. The assembly may comprise an operator control configured to move the seat back and the seat together. The seat may be configured to move continuously from the raised state to the default state to the lowered state to the recumbent state. The seat back may be configured to move to provide an upright position for the raised state and to provide a lounge position for the recumbent state and to provide a reclined position for the default state. The seat back may comprise a back frame configured to rotate relative the seat base. The assembly may comprise a recliner mechanism configured to move the seat back. The recliner mechanism may comprise an arm may be configured to (a) pivot about the seat back and (b) pivot about the seat base. The seat back may comprise a back frame comprising a first side and a second side; the recliner mechanism may comprise a motor coupled to the first side of the seat back frame. The recliner mechanism may comprise a sector; the motor may be configured to rotate the sector to move the seat back. The sector is coupled to the seat base. The motor may comprise a gear; the sector may comprise a set of teeth may be configured to mesh with the gear of the motor to guide movement of the seat back relative to the seat base. The recliner mechanism may comprise a drive tube coupled to the sector and the second side of the seat back frame, the drive tube may be configured to align movement of the first side of the seat back frame and the second side of the seat back frame. The recliner mechanism may comprise an arm coupled to the drive tube and the seat back frame at a pivot joint. The arm is coupled to the seat base at a pivot joint. The recliner mechanism may comprise an arm configured (a) to couple the drive tube to the seat base and (b) to couple the seat back frame to the seat base. The seat base may comprise a bracket coupled to the recliner mechanism. The bracket may comprise a set of brackets coupled to the recliner mechanism at a set of pivots. The bracket of the set of brackets is coupled to an arm of the recliner mechanism at a pivot joint. The bracket of the set of brackets is coupled to a sector of the recliner mechanism at a pivot joint. The sector may be configured to guide movement of the seat back relative to the seat base. The sector is coupled to a drive tube of the recliner mechanism; the drive tube is coupled to an arm of the recliner mechanism; the arm of the recliner mechanism is coupled to another bracket of the set of brackets at a pivot joint. The seat back may comprise a back frame, a back suspension and a back pad. The seat may be configured to move between a declined position; an inclined position; and a forward position. The assembly may comprise a link mechanism may be configured to move the seat between the declined position; the inclined position; and the forward position. The seat may comprise a seat base frame providing a cushion frame. The seat may comprise a cushion frame, the leg support, and a cushion panel may be configured to bridge between the cushion panel and the leg support. The leg support may comprise a cushion panel. The cushion panel may be configured to tuck the leg support under the cushion frame. The cushion panel may be configured to extend the leg support from the cushion frame. The cushion panel may be configured to change shape to accommodate the occupant. The cushion panel may be configured to flatten under load from the occupant. The leg support may be configured to move from a retracted position to an extended position through a downward position. The seat may comprise a cushion panel may be configured to facilitate movement of the leg support from the retracted position to the extended position through the downward position. The cushion panel may be configured to change shape to facilitate movement of the leg support. The cushion panel may comprise a spring steel panel. The assembly may comprise an extension mechanism may be configured to move the leg support from the retracted position to the extended position through the downward position. The extension mechanism may comprise a 2:1 gear ratio. The extension mechanism may be configured to move the leg support outward from the seat. The extension mechanism may be configured to increase a length of the seat. The assembly may comprise a recline control. The assembly may comprise a tilt control.

According to an exemplary embodiment as shown schematically in the FIGURES, a seat assembly for a vehicle interior may comprise a base and a back coupled to the base and a cushion coupled to the base. The assembly may be configured to move between a raised state, a nominal state, a lowered state and a recumbent state. The assembly may be configured to move continuously from the raised state to the lowered state through the nominal state. The assembly may comprise an operator control may be configured to move the back and the cushion together. The assembly may be configured to move continuously from the raised state to the nominal state to the lowered state to the recumbent state. The back may be configured to move from an upright position for the raised state to a lounge position for the recumbent state through a reclined position for the nominal state. The back may comprise a back frame may be configured to rotate relative the base. The assembly may comprise a recliner mechanism may be configured to move the back. The recliner mechanism may comprise an arm may be configured to (a) pivot about the back and (b) pivot about the base. The back may comprise a back frame comprising a first side and a second side; the recliner mechanism may comprise a motor coupled to the first side of the back frame. The recliner mechanism may comprise a sector; the motor may be configured to rotate the sector to move the back. The sector is coupled to the base. The motor may comprise a gear; the sector may comprise a set of teeth may be configured to mesh with the gear of the motor to guide movement of the back relative to the base. The recliner mechanism may comprise a drive tube coupled to the sector and the second side of the back frame; the drive tube may be configured to align movement of the first side of the back frame and the second side of the back frame. The recliner mechanism may comprise an arm coupled to the drive tube and the back frame at a pivot joint. The arm is coupled to the base at a pivot joint. The recliner mechanism may comprise an arm configured (a) to couple the drive tube to the base and (b) to couple the back frame to the base. The base may comprise a bracket coupled to the recliner mechanism. The bracket may comprise a set of brackets coupled to the recliner mechanism at a set of pivots. The bracket of the set of brackets is coupled to an arm of the recliner mechanism at a pivot joint. The bracket of the set of brackets is coupled to a sector of the recliner mechanism at a pivot joint. The sector may be configured to guide movement of the back relative to the base. The sector is coupled to a drive tube of the recliner mechanism; the drive tube is coupled to an arm of the recliner mechanism; the arm of the recliner mechanism is coupled to another bracket of the set of brackets at a pivot joint. The back may comprise a back frame, a back suspension and a back pad. The cushion may be configured to move between a declined position; an inclined position; and a forward position. The assembly may comprise a link mechanism may be configured to move the cushion between the declined position; the inclined position; and the forward position. The assembly may comprise a recline control. The assembly may comprise a tilt control. The assembly may comprise a leg support. The cushion may comprise a cushion frame, the leg support, and a cushion panel may be configured to bridge between the cushion panel and the leg support. The cushion panel may be configured to tuck the leg support under the cushion frame. The cushion panel may be configured to extend the leg support from the cushion frame. The cushion panel may be configured to change shape to accommodate the occupant. The cushion panel may be configured to flatten under load from the occupant. The leg support may be configured to move from a retracted position to an extended position through a downward position. The cushion may comprise a cushion panel may be configured to facilitate movement of the leg support from the retracted position to the extended position through the downward position. The cushion panel may be configured to change shape to facilitate movement of the leg support. The cushion panel may comprise a spring steel panel. The assembly may comprise an extension mechanism may be configured to move the leg support from the retracted position to the extended position through the downward position. The extension mechanism may comprise a 2:1 gear ratio. The extension mechanism may be configured to move the leg support outward from the cushion. The extension mechanism may be configured to increase a length of the cushion.

According to an exemplary embodiment as shown schematically in the FIGURES, a seat for a vehicle interior may be configured to move between a raised state, a nominal state, a lowered state and a recumbent state for an occupant comprising; the seat may comprise a base; a back coupled to the base; and a cushion coupled to the base.

According to an exemplary embodiment as shown schematically in the FIGURES, a seat assembly may comprise a base and a seat comprising a seat base and a seat back; the seat base may comprise a seat cushion; seat base is configured for movement relative to the base; the seat back is configured for movement relative to the seat base; the seat is may be configured to move between a raised state, a nominal state, a lowered state and a recumbent state; the seat base may comprise a leg support and a leg support mechanism. The nominal state may comprise a default state. The leg support mechanism may comprise a linkage and the leg support may comprise a support plate actuated by the linkage. The support member may comprise a panel or a panel sheet or a curved panel or a stiff panel or a panel member or a spring steel sheet or a tensile element or a biased spring member or a link sheet member or a support panel or a spring member or a spring member coupled to a frame of the seat base and a connector link of the linkage. The leg support may be configured to be actuated by mass and position of an occupant in the seat. The leg support may be configured to provide a floating feel for the occupant in the seat. The leg support may be configured to provide equilibrium for the occupant in the seat. The leg support mechanism may be configured to provide an equilibrium feel by movement in response to actuation and/or mass and position of the occupant. The leg support mechanism may be configured to provide an equilibrium feel by movement of the support plate. The support panel may comprise a support plate and movement of the support panel may comprise deflection and/or extension and/or retraction and/or bending. The leg support mechanism may be configured to provide an equilibrium by movement of the support plate and the linkage. The leg support mechanism may be configured to provide an equilibrium by deflection of the support panel.

According to an exemplary embodiment as shown schematically in the FIGURES, a component for a vehicle interior may comprise a seat assembly comprising a base and a seat comprising a seat base and a seat back; the seat base may comprise a seat cushion; seat base may be configured for movement relative to the base; the seat back may be configured for movement relative to the seat base; the seat base may comprise a leg support and a leg support mechanism. The leg support mechanism may comprise a linkage; the leg support may comprise a support member coupled to the linkage. The seat may be configured to move between a raised state, a default state, a lowered state and a recumbent state. The support member may comprise a panel or a panel sheet or a curved panel or a stiff panel or a panel member or a spring steel sheet or a tensile element or a biased spring member or a link sheet member or a support panel or a spring member or a spring member coupled to a frame of the seat base and a connector link of the linkage. The leg support may be configured to be actuated by mass and position of an occupant in the seat; the leg support may be configured to provide a floating feel for the occupant in the seat; the leg support may be configured to provide equilibrium for the occupant in the seat; the leg support mechanism may be configured to provide an equilibrium feel by movement in response to actuation and/or mass and position of the occupant; the leg support mechanism may be configured to provide an equilibrium feel by movement of the support member. The support member may comprise a support plate/panel; movement of the support member plate/panel may comprise deflection and/or extension and/or retraction; the leg support mechanism may be configured to provide an equilibrium by movement of the support member and the linkage; the leg support mechanism may be configured to provide an equilibrium by deflection and/or bending of the support member comprising a panel. The support member may comprise a compliant panel. The support member may be configured to bend and/or contour and/or deform; the support panel may comprise a curvature; the curvature may comprise a default curvature; the curvature may be responsive to an input; the curvature may be reactive to a load from an occupant. The seat base may comprise a nose; the nose may be configured to preserve a shape for the seat base; the shape of the nose may be responsive to a load from occupant; the nose may be configured for movement with the leg support; the nose may be configured to shift with the leg support; the leg support may comprise a leg extender; the nose may be configured to move with the leg extender; the shape of the nose may comprise a rounded shape. The support member may be configured to provide a form; the support member may be configured to deform under load and to return to a form; the form may comprise a default form; the form may comprise a curved form; the form deflects into a shape under load; the form may be configured to conform to input from an occupant; the form may be configured to conform to task from occupant; the form may comprise a default state of curvature; the support member may be configured to be put into tension under load; the support member may comprise a curved form at installation; the support member may be configured to provide a contour form in response to input from an occupant. The support member may comprise a bridge between a frame of the seat base and the linkage. The linkage may comprise a pivot point and/or a set of pivot points; the linkage may comprise a free pivot point and/or a set of free pivot points; the linkage may comprise a gear at a pivot point; the linkage may comprise a geared pivot point; the linkage may comprise a gear. The frame of the seat base may provide a stop for the leg support.

According to an exemplary embodiment as shown schematically in the FIGURES, a seat for a vehicle may be configured to move between a raised state, a nominal state, a lowered state and a recumbent state for an occupant comprising a base; a back coupled to the base; and a cushion coupled to the base. The seat may be configured to move continuously from the raised state to the lowered state through the nominal state. The seat may comprise an operator control configured to move the back and the cushion together. The seat may be configured to move continuously from the raised state to the nominal state to the lowered state to the recumbent state. The back may be configured to move from an upright position for the raised state to a lounge position for the recumbent state through a reclined position for the nominal state. The back may comprise a back frame configured to rotate relative the base. The seat may comprise a recliner mechanism configured to move the back. The recliner mechanism may comprise an arm configured to (a) pivot about the back and (b) pivot about the base. The back may comprise a back frame comprising a first side and a second side; the recliner mechanism may comprise a motor coupled to the first side of the back frame. The recliner mechanism may comprise a sector; the motor may be configured to rotate the sector to move the back. The sector may be coupled to the base. The motor may comprise a gear; the sector may comprise a set of teeth configured to mesh with the gear of the motor to guide movement of the back relative to the base. The recliner mechanism may comprise a drive tube coupled to the sector and the second side of the back frame; the drive tube may be configured to align movement of the first side of the back frame and the second side of the back frame. The recliner mechanism may comprise an arm coupled to the drive tube and the back frame at a pivot joint. The arm may be coupled to the base at a pivot joint. The recliner mechanism may comprise an arm configured (a) to couple the drive tube to the base and (b) to couple the back frame to the base. The base may comprise a bracket coupled to the recliner mechanism. The bracket may comprise a set of brackets coupled to the recliner mechanism at a set of pivots. A bracket of the set of brackets may be coupled to an arm of the recliner mechanism at a pivot joint. A bracket of the set of brackets may be coupled to a sector of the recliner mechanism at a pivot joint. The sector may be configured to guide movement of the back relative to the base. The sector may be coupled to a drive tube of the recliner mechanism; the drive tube may be coupled to an arm of the recliner mechanism; the arm of the recliner mechanism may be coupled to another bracket of the set of brackets at a pivot joint. The back may comprise a back frame, a back suspension and a back pad. The cushion may be configured to move between a declined position; an inclined position; and a forward position. The seat may comprise a link mechanism configured to move the cushion between the declined position; the inclined position; and the forward position. The seat may comprise a recline control. The seat may comprise a tilt control. The seat may comprise a leg support. The cushion may comprise a cushion frame, the leg support, and a cushion panel configured to bridge between the cushion pan and the leg support. The cushion panel may be configured to tuck the leg support under the cushion frame. The cushion panel may be configured to extend the leg support from the cushion frame. The cushion panel may be configured to change shape to accommodate the occupant. The cushion panel may be configured to flatten under load from the occupant. The leg support may be configured to move from a retracted position to an extended position through a downward position. The cushion may comprise a cushion panel configured to facilitate movement of the leg support from the retracted position to the extended position through the downward position. The cushion panel may be configured to change shape to facilitate movement of the leg support. The cushion panel may comprise a spring steel panel. The seat may comprise an extension mechanism configured to move the leg support from the retracted position to the extended position through the downward position. The extension mechanism may comprise a 2:1 gear ratio. The extension mechanism may be configured to move the leg support outward from the cushion. The extension mechanism may be configured to increase a length of the cushion.

### Exemplary Embodiments—Y

A component for a vehicle interior comprising a seat assembly is disclosed. The seat assembly may comprise a mounting/base and a seat comprising a seat base and a seat back; the seat base may comprise a cushion; the seat base may be configured for movement relative to the base; the seat back may be configured for movement relative to the seat base; the seat base may comprise a leg support and a leg support mechanism comprising a linkage; the support may comprise a support member coupled to the linkage. The support/member may comprise a stiff/compliant panel configured to bend/deform or contour in movement such as to provide an equilibrium effect in reaction/response to an input/load and/or mass and position of the occupant; the support/member may comprise a curved/spring panel. The seat may be configured to move between a default state, a raised state, a lowered state and a recumbent state.

TABLE A
SEAT POSITIONS

| | | | | Seat Base/ |
|---|---|---|---|---|
| | | | Seat | Cushion |
| Operation | Seat | Occupant | Back | (Lead Edge) |
| | Raised | Short Stature | Upright | Declined |
| Recline Control | Nominal | Median | Reclined | Mid |
| Tilt Control | Lowered | Tall Stature | Reclined | Inclined |
| Tilt Control | Recumbent | Lounging | Lounge | Forward |

TABLE B
SEAT POSITIONS

| | | | | Seat Base/ |
|---|---|---|---|---|
| | | | Seat | Cushion |
| Operation | Seat | Occupant | Back | (Lead Edge) |
| | Raised | Short Stature | Upright | Declined |
| Seat Control | Nominal | Median | Reclined | Mid |
| Seat Control | Lowered | Tall Stature | Reclined | Inclined |
| Seat Control | Recumbent | Lounging | Lounge | Forward |

TABLE C
SEAT POSITIONS

| | | | | Seat Base/ | |
|---|---|---|---|---|---|
| | | | Seat | Cushion | Leg |
| Operation | Seat | Occupant | Back | (Lead Edge) | Support |
| | Raised | Short Stature | Upright | Declined | Retracted |
| Recline Control | Nominal | Median | Reclined | Mid | Retracted |
| Tilt Control | Lowered | Tall Stature | Reclined | Inclined | Downward |
| Tilt Control | Recumbent | Lounging | Lounge | Forward | Extended |

TABLE D
SEAT POSITIONS

| | | | | Seat Base/ | |
|---|---|---|---|---|---|
| | | | Seat | Cushion | Leg |
| Operation | Seat | Occupant | Back | (Lead Edge) | Support |
| | Raised | Short Stature | Upright | Declined | Retracted |
| Seat Control | Nominal | Median | Reclined | Mid | Retracted |
| Seat Control | Lowered | Tall Stature | Reclined | Inclined | Downward |
| Seat Control | Recumbent | Lounging | Lounge | Forward | Extended |

TABLE E
REFERENCE SYMBOL LIST

| REFERENCE | |
|---|---|
| SYMBOL | ELEMENT, PART OR COMPONENT |
| V | Vehicle |
| VI | Interior |
| SZ | Seat assembly |
| BK | Seat back |
| B | Base/mounting frame |
| CN | Cushion/seat base |
| LS | Leg support/linkage/mechanism |
| LSa | Leg support link (e.g. base link) |
| LSb | Leg support link (e.g. connector link) |
| LX | Support structure |
| LM | Link mechanism |
| BP | Back pad (Foam) |
| BF | Back frame structure |
| BS | Back suspension/assembly |
| RR | Recliner mechanism |
| MT | Motor |
| DT | Drive tube |
| SR | Sector |
| RM | Arm |
| CP | Cushion pad (foam) |
| CF | Seat base frame/cushion frame |
| CFx | Seat base frame front/nose |
| CFp | Seat base frame plate |
| CS | Seat cushion suspension/assembly |
| PL | Leg support/support member (panel/plate) |
| | (e.g. cushion panel, spring steel plate, etc.) |
| GR | Gear |
| CT | Cross tube |
| BKF | Seat back frame |
| BKM | Seat back mechanism |
| CSF | Seat/base frame (e.g. seat/cushion frame) |
| CSM | Seat/base cushion mechanism |
| SZF | Seat frame/frame assembly. |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for a vehicle interior comprising:
a seat assembly comprising a base and a seat comprising a seat base and a seat back;
wherein seat base is configured for movement relative to the base;
wherein the seat back is configured for movement relative to the seat base,
wherein the seat base comprises a leg support and a leg support mechanism.
wherein the leg support mechanism comprises a linkage;
wherein leg support comprises a support member coupled to the linkage;
wherein the leg support mechanism is configured to facilitate movement of the leg support between a retracted position and an extended position.

2. The component of claim 1 wherein the support member of the leg support is configured for deflection and/or extension and/or retraction.

3. The component of claim 1 wherein the support member comprises a support panel configured to bend and/or contour and/or deform.

4. The component of claim 1 wherein the support panel comprises a sheet member comprising a shape.

5. The component of claim 1 wherein the linkage of the leg support mechanism is configured to facilitate movement of the leg support between the retracted position and the extended position.

6. The component of claim 1 wherein the support member of the leg support is connected to the seat base frame by the linkage of the leg support mechanism.

7. The component of claim 1 wherein the retracted position of the leg support comprises deforming of the support member; wherein the extended position of the leg support comprises extension of the support member.

8. The component of claim 1 wherein the support member comprises a support panel comprising at least one of a support plate or a curved plate or sheet steel or pre-stressed sheet steel or spring steel or a spring steel plate or a sheet member.

9. The component of claim 8 wherein the support panel is configured to deflect under a load.

10. The component of claim 8 wherein the support panel comprises the sheet member connected between the seat base frame and the linkage.

11. The component of claim 10 wherein the sheet member comprises at least one of a metal sheet and/or sheet steel and/or spring steel.

12. The component of claim 10 wherein the retracted position of the leg support comprises bending of the sheet member comprising the support panel; wherein the extended position of the leg support comprises flattening of the sheet member comprising the support panel.

13. The component of claim 1 wherein the linkage of the leg support mechanism comprises a base link and a connector link; wherein the support member of the leg support is connected to the connector link of the linkage of the leg support mechanism.

14. The component of claim 1 wherein extension of the leg support comprises extension of the linkage.

15. The component of claim 1 wherein the support member comprises the support panel; wherein the retracted position of the leg support comprises curving of the support panel and retraction of the linkage; wherein the extended position of the leg support comprises flattening of the support panel and extension of the linkage.

16. The component of claim 1 wherein retraction of the linkage comprises retraction of the linkage into the seat base frame.

17. The component of claim 1 wherein the sheet member is installed in a curved form; wherein the sheet member is configured to deform under a load and return toward the curved form after removal of the load.

18. The component of claim 1 wherein the sheet member provides a front of the seat base.

19. The component of claim 18 wherein the support member is configured to provide the shape of a curve at the front of the seat base when the leg support is in the retracted position; wherein the extended position of the leg support comprises extension at the front of the seat base by flattening of the support member.

20. A seat assembly for a vehicle interior comprising:
a base;
a seat coupled to the base;
wherein the seat comprises a seat base and a seat back;
wherein the seat is configured to be movable relative to the base;
wherein the seat back is configured to be movable relative to the seat base;
wherein the seat base comprises a seat base frame and a leg support;
wherein the leg support comprises a support member configured to provide a support for a leg of an occupant of the seat;
wherein the leg support is coupled to a leg support mechanism;
wherein the leg support mechanism comprises a linkage coupled to the support member of the leg support;
wherein the leg support mechanism is connected to the seat base frame;
wherein the leg support mechanism is configured to facilitate movement of the leg support between a retracted position and an extended position;
wherein the support member comprises a support panel and/or a support member and/or a sheet member.
